(19) United States
(12) Patent Application Publication
(10) Pub. No.: US 2005/0254440 A1
(43) Pub. Date: Nov. 17, 2005

(54) Private multimedia network

(76) Inventor: John D. Sorrell, Cherry Hill, NJ (US)

Correspondence Address: JOHN D. SORRELL, 1148 SEAGULL LANE, CHERRY HILL, NJ, 08003, US

(21) Appl. No.: 10/838,365

(22) Filed: May 5, 2004

(51) Int. Cl. H04N 7/14; H04Q 7/00

(52) U.S. Cl. 370/264; 348/14.08

(57) ABSTRACT

Private Multimedia Network (PMN) complements, and is an improved alternative to digital videoconferencing and multimedia delivery systems. PMN's desktop and meeting room delivery system is designed to support the exponential growth of enterprise team-based initiatives. PMN provides “one-stop-shopping” for the full multimedia rubric. It delivers user-friendly control and cost/effective TV and broadcast quality videoconferencing and other multimedia services to organizations with “critical mass” campuses and building complexes. Though digital systems dominate the videoconferencing marketplace, PMN's hybrid digital/analog architecture has no digital peer in breadth or quality of service within or between campuses. The novel architecture leverages advances in analog video short-haul technology, digital long-haul technology, and telephony audio and control technology to deliver four-level multimedia services: 1) premise; 2) campus; 3) multi-site; and 4) ubiquitous (any site with ITU compatible multimedia equipment (e.g., videoconferencing) and communication links). On balance, the price/performance afforded by PMN's centralized Telco-based control and audio delivery combined with its decentralized broadcast quality video distribution raise videoconferencing and other multimedia services to a new level of ubiquity. Just as telephones and PC LANs, PMN delivers expensive Boardroom and mobile cart videoconferencing capabilities to every desktop via existing multimedia wall plates. The key phases for this invention are: Lip-synchronization across differing network communication links and protocols; Ubiquitous multimedia service; Cost/effective room and desktop deployment; Telco control and audio; Broadcast quality video; Isochronous Quality; Centralized control and distributed operation; and Interoperable architecture.

I am claiming the date of my provisional patent (Patent Number 60375774, Private Multimedia Network, Apr. 30, 2003) as the patent date for this Patent application.

### BACKGROUND OF THE INVENTION

The invention relates to creation of a novel means to deliver cost/effective, desktop and meeting room, multimedia services throughout the organizational pyramid, from senior management to the front-line locus of decision-making, to point of customer interaction. To compete in today's marketplace, enterprises must be dynamic, and capable of responding quickly to changing market conditions on a global basis. However, the shift to a global economy has been a logistical challenge for enterprise management. Many organizations have flattened and streamlined their bureaucracies. To improve their organization's ability to deal with geographic dispersion, complexity, and change, senior managers have created lateral (cross-functional) teams. However, operational issues ranging from mundane management decisions to state-of-the-art innovation are dynamic processes that often require face-to-face contact with people not only across campuses but also around the globe. Post September 11, rising risk and inconvenience has significantly reduced travel. With the explosion of the “team concept,” employees are being tasked to serve on a variety of teams. Therefore, scheduling meetings within office campuses and large building complexes has become a logistical nightmare. But scheduled meetings are the tip-of-the-iceberg. Since most teams are engaged in creative processes, there is even greater demand for timely, ad hoc, meetings.

Senior management has turned to technology to provide timely, cost/effective, desktop solutions for the growing demand for face-to-face collaboration. Videoconferencing and other high-end multimedia services was once the sole province of the Boardroom and special meeting rooms. However, falling prices and growing demand for multimedia services that match the new business paradigms are transforming this once nice-to-have luxury into need-to-have tools for many businesses. Videoconferencing-based collaboration enables organizations to achieve faster time to market, reduce product development cycles and out maneuver competitors. The availability of powerful, distributed computers, broadband “information highways,” combined with “open system” standards now make it feasible to move information relatively cheaply in multiple directions (vertically, horizontally, networked) throughout an organization—information movement that mirrors the trend toward “networked” business processes and global commerce. However, though these networks deliver data efficiently and effectively, they are ill equipped to deliver high quality, real-time, multipoint, video to the desktop. The most notable objections to using contemporary videoconferencing solutions as a substitute for face-to-face meetings are lack of business-quality video and audio, and ease of use. Videoconferencing must be rich, fluid, full duplex, free of anomalies (e.g., ghosting, freeze frames), and have audio without echo, cross talk, or noticeable latency. Regardless of the user's level of expertise, jerky video, clipped audio, poor synchronization between lips and words, and echo from either side are serious drawbacks. It is estimated that up to 55% of how well a message is conveyed in person depends upon body language. However, the greatest barrier to the growth of videoconferencing is ease of use. Videoconferencing systems must be as easy, and as intuitive to use, as the telephone.

The conventional way of delivering videoconferencing and other forms of multimedia is digital. Narrowband solutions are abundant and inexpensive; however, quality broadband multimedia is still costly and technically challenging. Though the information highway provides substantial broadband capacity, the last hundred yard “off-ramps” that separate the door from the desktop are still the principal obstacle. CIO's have been slow to embrace LAN-based digital multimedia (e.g., videoconferencing) to the desktop because video streams need completely different network characteristics than data applications. With video, high bandwidth is not the issue. Video steams need fixed amounts of bandwidth through time, directly proportional to signal quality, resolution, and frame rate. Since digital LANs deliver data in bursts rather than as smooth isochronous flows, analog is a far better transport platform than digital for video. Analog is also video's original form; however, the communication highways that surround campuses and building complexes are digital. Therefore, to achieve optimal end-to-end connectivity, these seemingly incompatible technologies must work in tandem. Analog signals, which travel near the speed of light, must be synchronized with digital signals that travel at lower, erratic speeds, and exhibit noticeable latency delay.

Analog transmission is a way of sending signals—voice, video, data—in which the transmitted signal is analogous to the original signal. In other words, if you spoke into a microphone and saw your voice on an oscilloscope and you took the same voice as it was transmitted on the phone line and placed that signal onto the oscilloscope, the two signals would look essentially the same. The only difference would be that the electrically transmitted signal would be at a higher frequency. Analog video signals represent an infinite number of smooth transitions between video levels. TV signals are analog. By contrast, a digital video signal assigns a finite set of levels—a subset of the analog spectrum. Though a variety of medium can transmit analog signals (e.g., fiber, wireless), analog is typically transmitted over twisted pair wirelines. Analog is superior to digital for video transmission and twisted pair wirelines are abundant and strategically located across the enterprise (e.g., desktops, meeting rooms, executive suites). Analog is not without it's problems. Analog transmission is plagued by resistance and noise problems that impose stringent distance constraints; Distance constraints that are far more stringent for video than audio (e.g., telephone). Electromagnetic interference, which weakens, or attenuates signals, prevents long distance transmission. This problem is particularly true of electrical signals carried over twisted pair copper wire because of the high level of resistance in the wire. Resistance is directly proportional to wire length—the longer the wire, the greater the resistance. Attenuation is sensitive to carrier frequency. High frequency signals attenuate more than lower frequency signals. Signals also tend to pick up noise (e.g., static, cross talk) as they traverse the network. Twisted pair copper wires tend to act as antennae. They absorb noise from outside sources of Electromagnetic Interference (EMI). Noise distorts and degenerates signal quality. To overcome these problems, analog amplifiers are used to boost signal strength back to its original value. However, after successive signal amplifications, noise accumulates until the original signal becomes unintelligible. There are now analog transceiver products in the marketplace that have overcome these problems, and some, with amplification, are capable of transmitting analog signals for miles over twisted pair wire lines. Furthermore, if audio is transmitted by a different means, the cost and use of existing dark twisted pair wirelines and attendant audio appliances, communication, and switching equipment can be cut in half. Additional capacity is made available to improve video signal quality. Since LAN ports tend to be only 1,500 to 2,000 feet from head-in servers, distance is no longer a problem. Today, the greatest bottleneck to delivery of cost/effective, ubiquitous, videoconferencing and other forms of multimedia is lack of an architecture that combines digital and analog technology.

In many respects, analog audio is an even more formidable and expensive problem than video in delivering multimedia to the desktop. Contemporary systems use microphones, which are extremely susceptible to audio feedback, especially in adjacent cubicles (e.g., near-end/far-end cross-talk, echo). Supporting audio for conferees in adjacent cubicles is a technological challenge. However, billions have been invested by the Telco industry to solve audio deployment problems. Cutthroat competition and oversupply have lowered the cost of Telco audio to commodity pricing. However, because of lip-synching problems inherent in mixing digital and analog technologies, and even different digital technologies, Telco audio has not been used for videoconferencing and other forms of multimedia applications. Furthermore, with the marketplace preoccupation on digital in-band multimedia solutions, there has been little need to explore mixed out-of-band digital and analog video, and Telco audio solutions.

Another multimedia deployment problem is lack of user friendly, ubiquitous, multimedia and meeting room control systems. Until recently, touch panels, specialized keypads, and wireless remote have been the state-of-the art. Currently, networked control systems are finding growing acceptance. High-end meeting room multimedia systems use expensive codecs for switching, which are controlled by wireless remotes. These devices add cost to the system and, like the TV remote control, lack standardization. Since there is no widely accepted control standard, most control devices in the marketplace have microprocessors with differing interfaces and features. In many settings, devices from several manufacturers are used, resulting in multiple control units that are confusing and cumbersome to the user. AMX has built a business around providing a variety of solutions to this problem with their proprietary, specialized, devices.

Telephones are a far more ubiquitous and standardized control medium. Telephones are located throughout the enterprise, and most modem telephone systems have “open” architectures. However, since telephones are not considered to be part of the multimedia rubric, they are not used to control videoconferences and multimedia related services (e.g., distance learning, media-on-demand); Controls that range from management control (policy conformance) to operational control (session setup, signal switching, device management, and session tear-down). One significant hurdle that has blocked the effective utilization of computer-telephone technology has been the historical lack of communication between practitioners of the information processing and telephony disciplines. In recent years, adherence to new standards, such as, Computer-Supported Telephony Application (CSTA) call modeling, ECMA protocol standards, and application programming interface (API) specifications for ISDN D-channel, Computer Telephone Interface (CTI) links for modem PBXs, and Signaling System 7 (SS7) switch to switch signaling protocol for public networks have moved computer-telephone technology light years forward. The leading multimedia equipment vendors have well-defined APIs that can easily be programmed for Telco multimedia control.

Digital videoconferencing systems use pricey embedded multipoint control units (MCUs) to deliver multipoint video and audio videoconferencing service. MCUs are bridging or switching devices that deliver “continuous presence” video and audio. “Continuous Presence” technology displays each participant in a videoconference in a matrix structure similar to Hollywood Squares, a popular TV show. Each participant's video is full color and full motion. Voice switched video, another popular videoconference format, only displays the active speaker rather than all participants. Though high-quality MCUs deliver NTSC, 30-frame per second video, they only deliver bridging services to the location of the codec rather than all desktops in the facility.

Full recognition of the many problems associated with delivery of broadcast quality videoconferencing and other forms of multimedia to desktops and meeting rooms is part of my invention rather than prior art.

### BRIEF SUMMARY OF THE INVENTION

PMN is the first practical VideoPhone for public and private sector enterprise use. Many prior art systems tout “VideoPhone” service, but most use embedded microphones and speakers. Rather than a standalone apparatus, PMN is a “virtual” VideoPhone that leverages existing equipment. Just as a Telco, control is at a Central Office. Existing telephones (desktop or portable) are used to communicate service requests, signaling, and audio (microphones and speakers). However, just as with Telco utilities, intelligence is centralized. Prior art that claims use of existing telephones requires direct interface connections to their control units rather than use of telephones in their native state.

Conscious of desktop footprint requirements, PMN only requires a monitor, telephone, and dark twisted pair wireline, which exist in abundance in most enterprises. To that, we add, a camera an analog video transceiver. PMN requires little training because the telephone is intuitive. Everyone knows how to use the telephone. With IVR guidance, PMN user friendliness even surpasses PSTN and commercial conference service offerings. PMN is the only multimedia system that combines state-of-the-art PBX control with high quality video (boardroom level) and ubiquitous Telco audio. By combining existing enterprise Telco resources (telephone and wirelines) with scalable Video PBX services, PMN enables cost/effective, enterprise-wide, deployment of desktop videoconferencing by the hundreds and thousands; not just the dozens endpoints we find to day in enterprise conference rooms. Our design perspective differs from the competition. PMN is designed top-down, as an open architecture that provides standards-based interoperability for all rich media applications; Services that are delivered “out-of-band” through independent tributaries that converge at the desktop: Telco control and bridged voice, local circuit switched and bridged analog video combined with long-distance digital switched and bridged vide, and web and enterprise computer system data. In contrast, end-point hardware vendors design bottom-up to protect proprietary end-points. End-point vendors, the market share leaders, provide “in-band” services that share a common pipe. These polar differences have a major impact on both operational effectiveness and the enterprise bottom line.

As discussed in “Background Of The Invention,” the greatest barrier to cost/effective, ubiquitous, desktop multimedia services is lack of an architecture that combines digital and analog technology on a single platform; An architecture that overcomes the following problems: 1) Digital multimedia short-haul limitations; 2) Analog multimedia long-haul limitations; 3) Audio deployment engineering problems; 3) Lack of mixed analog and video media synchronization; 4) Lack of ubiquitous end-user system control; and 5) High cost per node for NTSC quality multimedia. Given these issues, we used the power of problem decomposition to define the prerequisites for the Private Multimedia Network (PMN) architecture. As shown in FIG. 1, we separated the problem into four facets: 1) short and long haul audio and video, switching and bridging, and communication links; 2) short and long haul synchronization; 3) Telco-based Control; 4) Telco-based audio (microphone and speaker).

As shown in FIG. 1, to address both long and short haul communication transport issues, we used the strengths while avoiding the weaknesses of digital [1] and analog [3] technologies. Digital technology, which is ubiquitous, is far more adept than analog at delivering cost/effective long haul, transcontinental and even global, broadband, multipoint, multimedia service. The quality of interconnect service is dependent on the quality of the weakest link: Codec, Multipoint Control Unit (MCU), communication link (e.g., IP, ISDN), and transport medium (fiber, satellite, wireless, wireline). To best match analog quality, PMN deploys boardroom-level quality digital equipment. In contrast, analog is far more adept than digital at delivering cost/effective short haul, broadband, multipoint, multimedia service to desktops in campuses and building complexes. Components include: Multimedia Switch, Continuous Presence Engine (Multiviewer bridge), Multimedia LAN, and transport medium (twisted pair wireline).

Since digital MCUs and analog Continuous Presence Engines are expensive resources, a viable alternative, and our preferred embodiment, is Telco-based Voice-Switched-Video (VSV) and variants thereof (e.g., Host-Directed-Video (HDV), Participant-Requested-Video (PRV)). All of these services are Telco-based. VSV is triggered by analysis of conference bridge data. Handset signaling triggers HDV and PRV

To overcome the digital/analog synchronization problem caused by digital latency, PMN uses the digital long-haul transport means [1] to synchronize inter-site audio and video signals. Synchronization corrects video and analog lip-synching and video stream timing differences. Therefore, inter-site ubiquitous communication is achieved by combining the digital-based and analog-based methodologies. PMN delivers the synchronized video and audio signals to end-users via different “real-time” means: video by the premise short-haul analog communication links [3], and audio by the central site Telco audio bridge [2]. Within a campus or building complex, just analog is used to deliver video.

To address audio engineering problems, PMN uses robust and scaleable Telco technology to overcome desktop deployment problems (e.g., echo, cross talk).

To address lack of cost/effective, ubiquitous, end-user system control, PMN uses telephony control technology. No additional equipment is necessary. Telephones are readily available to end-users throughout the enterprise. PMN uses Telco IVR and existing telephone handset keypads to enable end-users to setup, control, and teardown multimedia sessions, and also control appliances, switches, servers, and gateways throughout the enterprise.

To address the last price/performance issue, high cost per node, PMN centralizes and manages the sharing of expensive resources (e.g., codecs, MCUs, gateways, switches), uses existing enterprise wirelines and appliances (e.g., telephones, TVs, computers), and minimizes deployment of dedicated PMN computers. Rather than using codecs as end-points, they are centralized in a rack mount for use as a shared enterprise resource. Use of Telco for both audio and control has a significant impact on the bottom line. Audio and control are at least half of the cost of multimedia system deployment. With PMN, multimedia service requires only installation of a video camera and transceiver at each node Since videoconferencing was developed, and has grown outside of the data processing department, contemporary systems lack many of the management and operational control capabilities that are built-in to most enterprise-wide information systems. PMN centralizes management control (policy), distributes system management (configuration and administration), and decentralize operational control (conference setup, operation, and tear-down). Just as telephone calls, there is no chauffer; end-users are in control of conferences from end-to-end. Just as with telephone calls, the man/machine interface is intuitive, and the operating system insures that all tasks are accomplished effectively and efficiently mirroring Telco quality. However, there can be no real freedom without control. Unobtrusive management control and system management are provided to insure that resources are obtained and used effectively and efficiently in the accomplishment of the organization's goals (e.g., budget conformance, “transfer priced” services, long distance call restrictions). Just as with other effective enterprise-wide information systems, PMN is customized at installation to match the enterprise control structure, and provides on-going conformance reports that compare operations against expected service levels.

As depicted in FIG. 1 to 11, an exemplary embodiment of PMN's three-level delivery system includes: 1) Central Network Management System (NMS), which includes a PC server with Interactive Voice Response (IVR) and audio bridge boards, and NMN operating system software that delivers system management (maintenance and conformance to enterprise management control policies), conference management (setup, control, tear-down), and control of premise peripherals (e.g., codecs, hyper telephones, multimedia switches, video and TV servers, and continuous presence engines and audio mixers, as needed); 2) Premise head-in shared resources (e.g., codecs, hyper telephones, multimedia switches, video and TV servers, continuous presence engines, audio mixers, and “plug-and-play” head-in HUB); and 3) Desktop and meeting room multimedia appliances (“plug-and-play” desktop HUB, telephone appliances, PCs, PC video tuner cards, TVs, video cameras, and microphones and speaker systems, as needed).

PMN's capabilities are not limited to point-to-point and multipoint videoconferencing. PMN's ubiquitous and interoperable multi-site architecture delivers a full range of simplex and duplex multimedia services to desktops, meeting rooms, and executive suites. For example: 1) Multimedia On-demand (1 to 1 applications, e.g., cable TV, steaming media); 2) Video and Voice Mail (1 to 1 applications); 3) Distance Learning (1 to many applications); 4) Monitoring and Mentoring video conference, Distance Learning, Medical Procedures (1 to many applications); 5) Broadcasting and Advertising (1 to many applications); 6) Surveillance (1 to many applications); and 7) Controlling enterprise-wide multimedia appliances and servers.

Numerous other exemplary embodiments and alternatives of the invention are also discussed with the understanding that other equivalents are also included. Network Management System (NMS) provides core horizontal capabilities that make a wide array of multimedia applications beyond the scope of traditional videoconferencing and other multimedia applications practical; Yet-to-be-discovered applications will result from creative minds empowered by the PMN architecture and underlying technology exploring new vistas of their discipline: Vertical market applications, such as: Telecomputing, Telemedicine-Teledent-Teleradiology, Sales and Customer Service, Career Services, Video Justice, Security, Smart Buildings, Financial services Kiosks, and Multimedia Advertising.

### BRIEF DESCRIPTION OF THE DRAWINGS

FIG. 1 is a diagram of the PMN Conceptual Design,

FIG. 2 is a diagram of the PMN Architecture and Information Flow from a “Big Picture” perspective,

FIG. 3 is a diagram of the PMN Architecture and Information Flow from a premise and PMN Control Center perspective,

FIG. 4 is a diagram of PMN Enterprise Premises and Information Flow from an Inter-site perspective.

FIG. 5 is a diagram of the PMN Multimedia Switch with Examples of Attached On-demand Servers, and Switching and Communication Hardware,

FIG. 6 is a diagram of the PMN Information Flow from a Telco perspective. This diagram focuses on Single Site, Point-To-Point, Collaboration and is followed by its related session startup process, FIG. 6.1 and operational flow FIG. 6.2,

FIG. 7 is a diagram of the PMN Information Flow from a Telco perspective. This diagram focuses on Single Site, Multiparty Voice Switched Collaboration and is followed by its related session startup process, FIG. 7.1 and operational flow FIG. 7.2,

FIG. 8 is a diagram of the PMN Information Flow from a Telco perspective. This diagram focuses on Single Site, Multiparty, Continuous Presence Collaboration and is followed by its related session startup process, FIG. 8.1 and operational flow FIG. 8.2,

FIG. 9 is a diagram of the PMN Information Flow from a Telco perspective. This diagram focuses on Multisite, Point-To-Point Collaboration and is followed by its related session startup process, FIG. 9.1 and operational flow FIG. 9.2,

FIG. 10 is a diagram of the PMN Information Flow from a Telco perspective. This diagram focuses on Multisite, Multiparty, Voice Switched Video Collaboration and is followed by its related session startup process, FIG. 10.1 and operational flow FIG. 10.2,

FIG. 11 is a diagram of the PMN Information Flow from a Telco perspective. This diagram focuses on Multisite, Multiparty, Continuous Presence Collaboration and is followed by its related session startup process, FIG. 11.1 and operational flow FIG. 11.2,

### DETAILED DESCRIPTION OF THE INVENTION

Invention Design Precepts

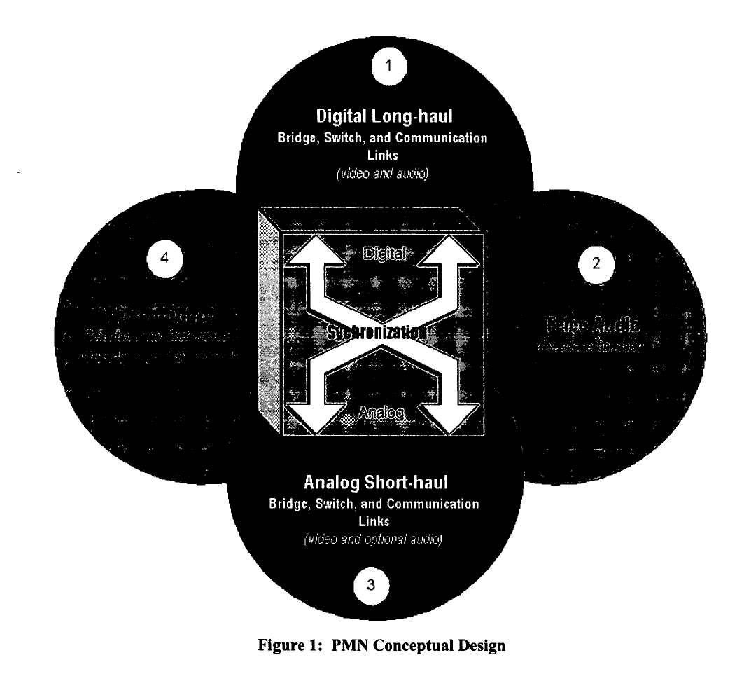

As shown in FIG. 1 and described in Brief Summary Of The Invention, Private Multimedia Network (PMN) is a hybrid analog and digital architecture that capitalizes on advances in telephony, and analog and digital transmission technology, while avoiding their weaknesses. In contrast to contemporary multimedia management systems (e.g., videoconferencing systems), services are delivered “out-of-band” through independent tributaries that converge at the desktop: Telco control and bridged voice, local circuit switched and bridged analog video combined with long-distance digital switched and bridged video, and web and enterprise computer system data. Contemporary systems share a common pipe to the desktop (e.g., IP, ISDN, Internet). PMN's novel architecture leverages the economy of resource sharing, and exploits advances in short-haul analog multimedia switching, bridging, and communication technology, long-haul digital multimedia switching, bridging and communication technology, and PSTN telephony audio and control technology to deliver end-to-end synchronized multimedia services. Using the power of problem decomposition, the inventor separated video, audio, switching, bridging, control, and communication links (short-haul versus long-haul) into independent problems requiring independent solutions that could be combined to work in tandem. With breakthroughs in analog resistance, noise, and distance constraints, analog is superior to digital for short-haul communications, switching, and bridging. Digital is superior to analog for long-haul communications, switching, and bridging. The problem is short and long haul synchronization, and effective operational and management control.

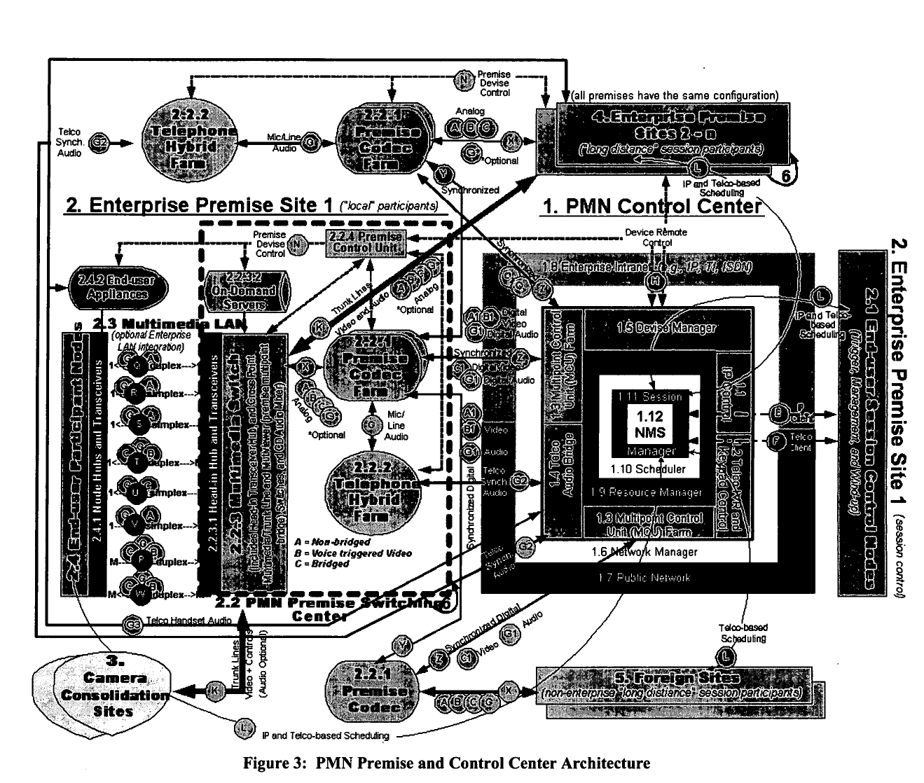

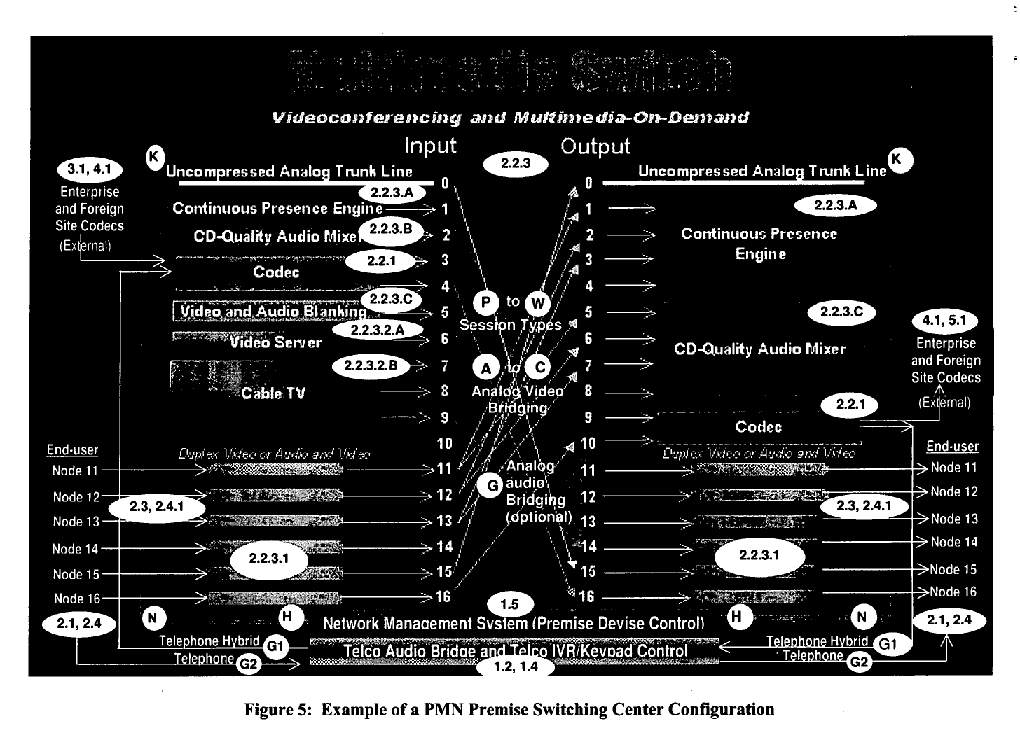

As shown in FIG. 3, for short haul communications, the inventor uses existing enterprise twisted pair wirelines and marketplace transceivers for analog video transmission [FIGS. 3 and 5 (2.2.3.1, 2.3. 2.4.1)]; uses marketplace cross-point switches for analog video switching to/from end-user nodes [FIGS. 3 and 5 (2.2.3)]; uses three alternative approaches to multipoint video: 1) Continuous Presence—uses marketplace Multiviewers [FIG. 5 (2.2.3.A)] to that multiple video inputs and create a single mosaic output similar to the TV show “Hollywood Squares”; 2) Voice-Directed-Video (VDV)—uses the Telco-based audio bridge [1.4] to identify the “active speaker” and uses the cross-point switch [FIGS. 3 and 5 (2.2.3)] to display the “last speaker” on the “active speaker's” monitor and the “active speaker” on all other participant monitors; 3) Host-Directed-Video (HDV) and Participant-Requested-Video (PRV)—similar in operation to VDV, HDV uses the telephone handset keypad to signal the Cross Point Switch [FIGS. 3 and 5 (2.2.3)] to make a specific participant the “active speaker”; PRV requests that the host make them the “active speaker” (similar to raising your hand to request the floor). Since analog and digital bridging equipment is expensive, VDV, HDV, and PRV are the preferred bridging embodiments.

For long-haul communications (inter-site switching), the inventor uses marketplace high bandwidth codecs with boardroom quality to approach the quality of the analog signals. Since high quality codecs are a scarce resource, they are pooled and managed as a shared resource at each premise [2.2.1]. Though many codecs offer embedded Multipoint Control Units (MCUs) [1.3] for bridging, the inventor choose to shift these resources to a central site for economy and improved service. Centralized MCU service is the preferred embodiment.

As discussed in short haul, audio is delivered via Telco audio bridging hardware and software [1.4], PSTN Telco networks, and existing telephones rather than microphones and speakers, which are used by contemporary videoconferencing systems. Therefore, the challenge is to deliver “lip-synched” Telco audio, which is real-time and isochronous, when inter-site digital video transmission (e.g., IP, T1, Ethernet, ISDN) is not real-time and is beset by latency? As we discussed, there are now products in the marketplace that transmit high quality analog signals miles rather than feet. Therefore premise communication is not a problem. The inventor's solution to the inter-site analog/digital synchronization problem is to send collaborator real-time audio and video via digital gateways [2.2.1, 1.3] that provide state-of-the-art synchronization capabilities. Then completing video delivery to the desktop (2.4) using analog transceivers [2.4.1, 2.2.3.1] that transmit video over existing enterprise twisted pair wirelines (Multimedia LAN [2.3]) for display on End-user [2.4] display devices (e.g., TV, PC monitor). After synchronization, audio follows a different route to the desktop. Using Telephone Hybrids [2.2.2] that interface to codecs [2.2.1] and to public network Telco services [1.4], synchronized audio [G3] is delivered via the enterprise telephone network to End-user [2.4] telephone handsets. Since video and audio signals are real-time, there is no loss of synchronization as the audio and video signals travel from the codec [2.2.1] to the desktop [2.4].

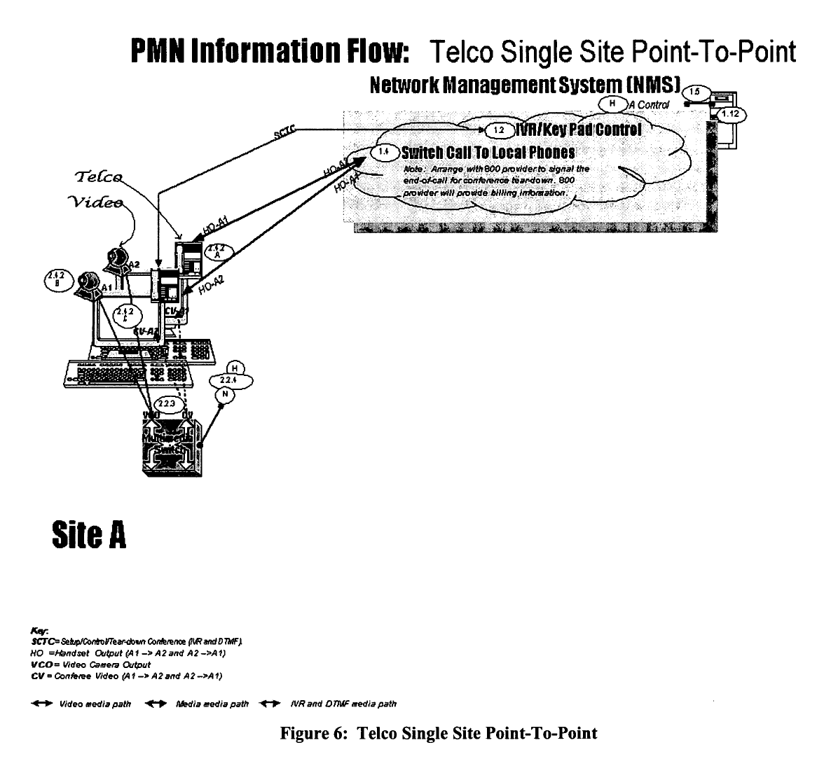

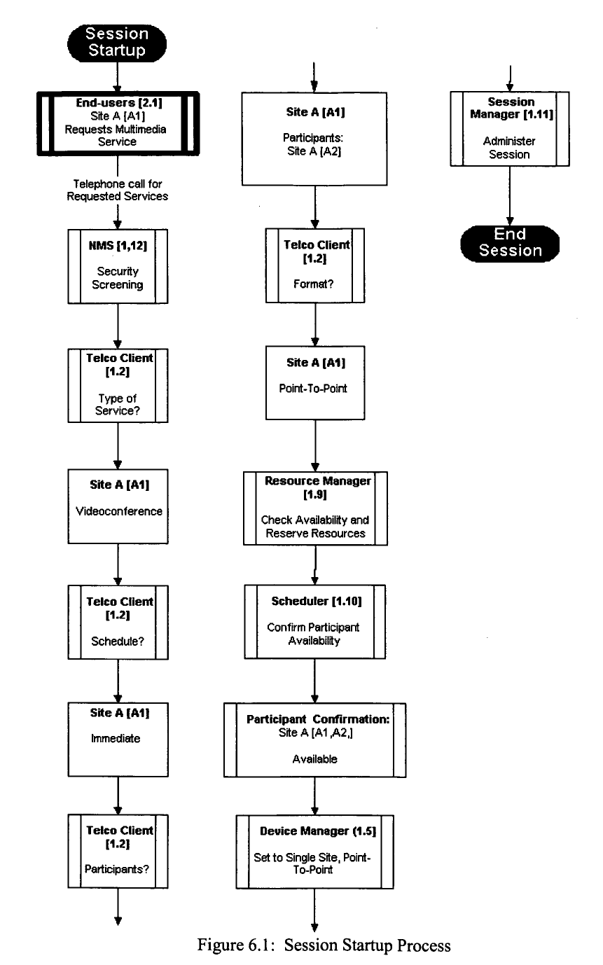

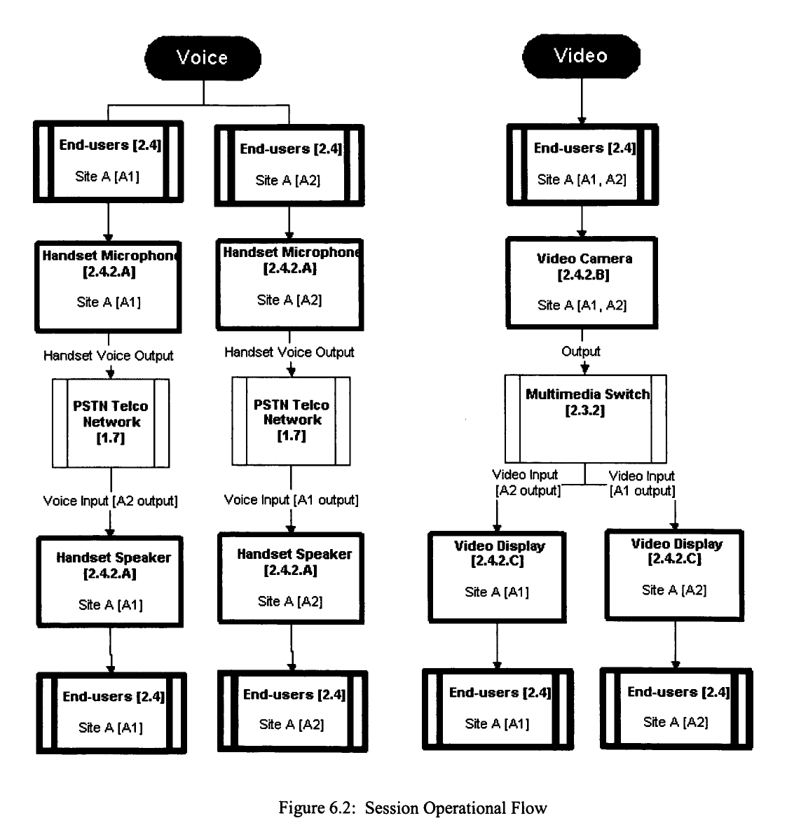

Videoconferencing gateway vendors (e.g., codec and MCU (Multipoint Control Unit) vendors) have developed sophisticated technology to solve multi-site digital communication link synchronization problems. However, high-end videoconferencing gateway products are costly and are designed for standalone meeting room use rather than networked use. By interconnecting these gateways to PMN input/output ports at each site, we achieve both end-to-end synchronization and networking. The sending gateway converts analog signals to digital signals for transport and the receiving gateway converts digital signals back to analog. After synchronization, PMN delivers gateway output to collaborators via two real-time paths: 1) audio via centralized Telco audio conference bridges [1.4, G3, 2]; 2) Video via premise Multimedia Switch and LAN [2.3]). Though the paths to conferees differ, delivery of synchronized video and audio signals are via real-time communication links; Communication links that eliminate “lip-synching” and video stream timing problem. In topologies with long-distance end-to-end real-time transmission (e.g., uncompressed fiber and wireless) (K), synchronization is unnecessary. FIGS. 6 to 11 provide different views of this inter-site collaboration process.

As shown on FIG. 3, control is the last hurdle to cross. Just as with audio, the inventor uses telephony control technology [1.2] and existing telephones [2.4.2] for operational and management control. No additional equipment is necessary. Telephones are readily available to end-users throughout the enterprise. PMN uses Telco IVR and existing telephone handset keypads to enable end-users to setup, control, and teardown multimedia sessions, and also to control appliances, switches, servers, and gateways throughout the enterprise [1.5, 2.2.4]. NMS' novel telephony/computer architecture also supports deployment of multimedia in environments where there are no computers (e.g., hotel rooms). Session and data management, which are Telco controlled, are delivered by telephone, and video is delivered via television. The only additional appliance needed in this configuration is a video camera and transceiver. NMS' telephony-based approach not only reduces engineering complexity, it significantly reduces cost per node.

End-to-end quality is the hallmark of PMN multimedia services. Since PMN conforms to communication industry standards (e.g., ITU), it provides an interoperable platform for “best-of-breed” technologies. Videoconferencing within the campus or building complex is broadcast quality. Between sites, quality is gated by the quality of the inter-site communication link (e.g., fiber, wireless, twisted pair) and codecs (e.g., IP, ISDN). PMN supports all standard communication links and codecs. By pooling and fully utilizing high-quality codecs, PMN raises the enterprise-wide quality bar to boardroom quality at a far lower cost per call than is possible with dedicated codecs. By leveraging existing telephone and twisted pair structured wiring assets, eliminating duplicate and overlapping communication link capabilities, and pooling and managing system capital asset resources, PMN optimizes cost/benefit.

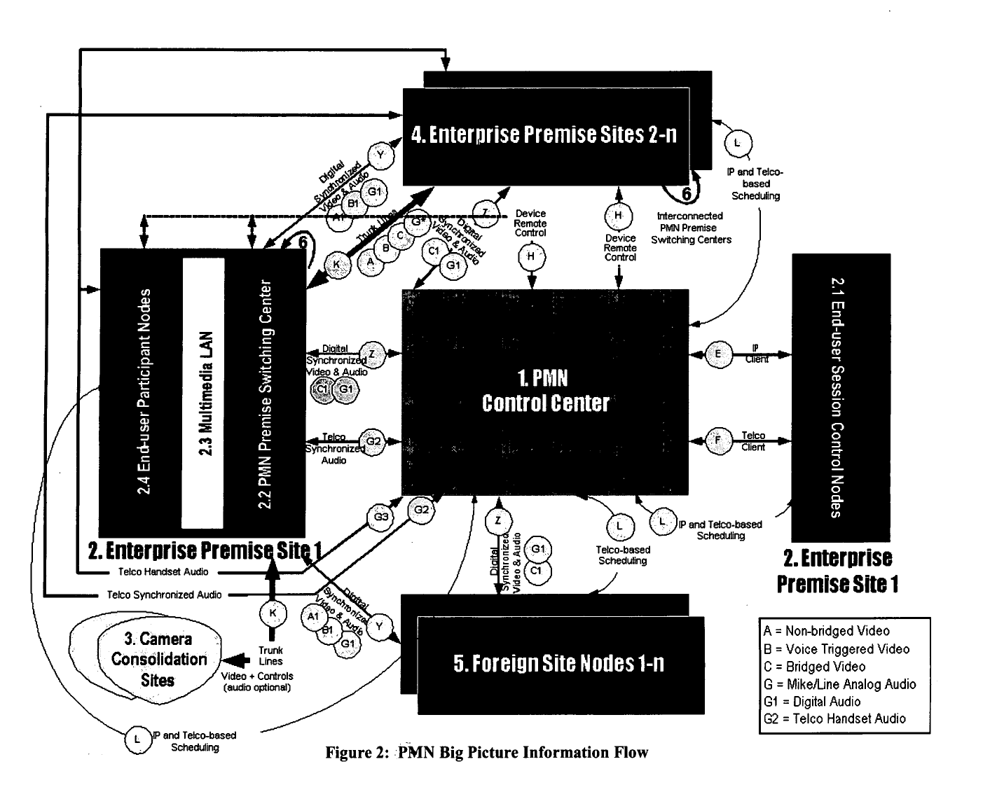

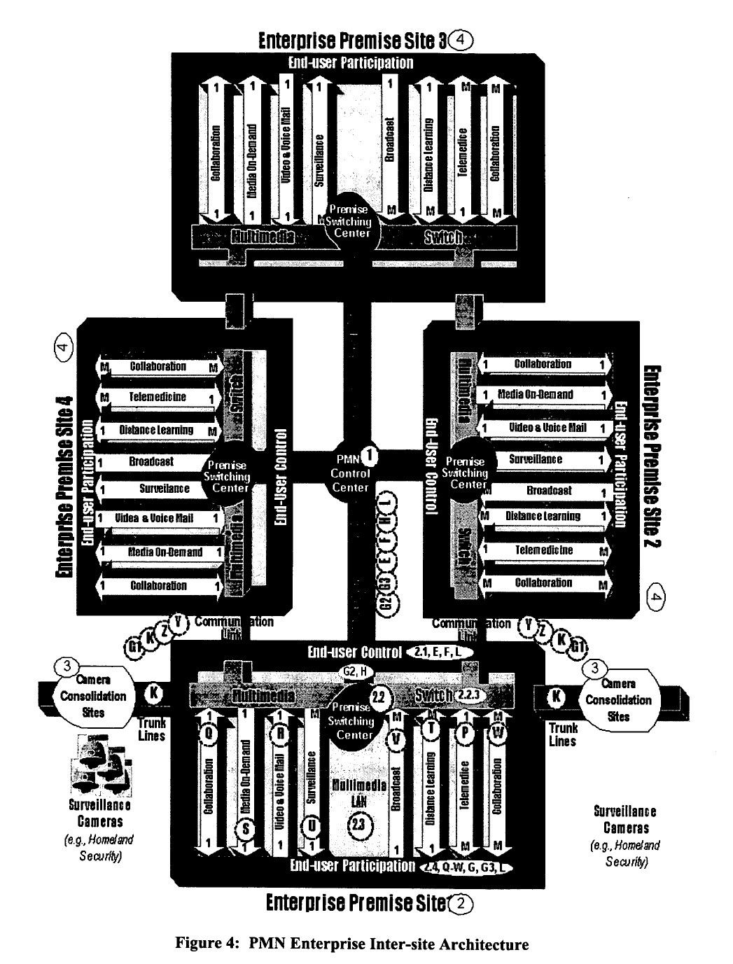

FIGS. 1 to 11 illustrate how PMN manages the collective multimedia facilities for an enterprise. FIGS. 1 and 2 put PMN pieces together: Premise, Intra-Campus, Inter-Campus, and Ubiquitous. This model fits organizations of all sizes. FIG. 4 shows how Enterprise-wide video collaboration is accomplished by replicating the model depicted in FIGS. 2 and 3 at each premise or campus throughout the enterprise. FIG. 5 is a description of the PMN Premise Switching Center, the heart of the system. FIGS. 5 through 11, which depict Telco-based collaboration scenarios, will be discussed after introducing and defining the FIG. 2 to 5 system components.

Private Multimedia Network (PMN) Overview

FIG. 2 is a diagram of the PMN Architecture from a site perspective. PMN is composed of 6 site types and service levels: 1) enterprise premises [2,4]; 2) enterprise campuses (interlocked premise Multimedia Switches [FIG. 3 (2.2.3 and FIG. 5)]; 3) enterprise proximity sites [2,4] (linked by “real-time” trunk lines, e.g., fiber) [K]; 4) enterprise geographically dispersed sites [2,4] (linked by non-real-time long-distance services, e.g., IP) [Z, Y]; 5) foreign nodes [5] (ubiquitous service to locations outside the enterprise); 6) Camera Consolidation sites [3] (consolidation points for collection of surveillance camera video from geographically dispersed). We define an enterprise as one or more public or private sector organizations that operate as a single entity in their use of the Private Multimedia Network (PMN); Organizations that share common operating rules and system configuration. Since Foreign site nodes [5] do not have PMN Premise Switching Centers [2.2], service to these sites is constrained by limitation imposed by their videoconferencing system (e.g., codec capabilities).

Rather than reinventing the wheel, the inventor has used best-of-breed products, where they exist, and has focused invention where the marketplace has no solution. By employing telephony/computer integration, the inventor has not only significantly reduced the cost of deployment; he has also simplified media and session setup and control (no training is required to use a phone keypad) and improved the end-to-end quality of both audio and video signals. To setup, control, and “tear-down” sessions, Enterprise End-user Nodes [2.1] communicate with the PMN Control Center [1] via Telco [F] and/or IP [E] Client commands. Telco IVR and handset keypad are the preferred control embodiment. Within management control constraints and available resources, PMN Control Center [1] reserves resources and performs device setup, control, and “tear-down” via Device Manager [H]. As discussed in End-user Session Control [2.1] and Participant [2.4] Node, session participants [2.4] are involved in session scheduling [L] as well as control, as needed, during a session. The following data types flow between premises and nodes: A=Non-bridged video, B=Voice Triggered Video, C=Bridged video, G=mike/line analog audio, G1=digital audio, G2=Telco handset audio. The PMN architecture provides two levels of bridging: 1) Inter-site via the PMN Control Center; 2) Intra-site via the PMN Premise Switching Center.

Each Enterprise Premise Site participating in a session has one or more PMN Premise Switching Centers [2.2], Multimedia LANs [2.3], and End-user nodes (communication network points-of-use). If the session is multiparty and bridging is requested, the PMN Control Center [1] Multipoint Control Unit [FIG. 3 (1.3)] serves as a middleman between premise Multimedia Switching Centers [2.2], bridging and synchronizing collaborator digital video and audio [C1, G1] via communication link [Z]. Otherwise, the session is either point-to-point or multiparty voice switched video. Participant premise Multimedia Switching Centers [2.2] communicate directly; exchanging synchronized digital audio [G1] and video [A1, B1] via communication link [Y]. Inter-site communication with Foreign site nodes [5] works in a similar manner via communication links [Z and Y]. Since bridged Telco audio is delivered to end-user telephone handsets [2.4] via the PMN Control Center conference bridge [FIG. 3 (1.4)], the Switching Centers also must exchange synchronized Telco audio [G2] with the PMN Control Center [1]. Foreign site nodes [5] have no Telco audio support.

Just as the PMN Control Center [1], The PMN Premise Switching Center [2.2] provides switching, bridging, and communication link services. It serves as the middleman between inter-site and premise end-user node communication. Just as with telephone calls, the Switching Center [G.2] establishes a “nailed-down” circuit between external communication nodes [3,4,5] via the Codec Farm [FIG. 3 (2.2.1)], and the premise end-user node [2.4] via the Multimedia LAN [2.3]. These are considered to be “long-distance” calls. Sessions between participants and resources within the premise or campus (interconnected switches), or served by trunk lines (analog) [K] with “nailed down” switch nodes are handled solely by Premise Switching Centers. These as considered to be “local calls”.

For sessions requiring surveillance camera coverage with or without participant collaboration (e.g., Homeland Security), PMN Premise Switching Center [2.2] allows end-users to use the telephone keypad to select and display camera video on a common screen with videoconferencing participant video. All participants can see both the participants and the surveillance cameras.

FIGS. 3 to 11 continue this discuss of the PMN architecture in greater detail and from different perspectives.

Private Multimedia Network (PMN) Detail Design

FIG. 3, a drilled-down version of FIG. 2, depicts the PMN hardware and software deployed at premises and the PMN Control Center. The Control Center can either be at a location within the enterprise or provided as a commercial service for one or more subscribers.

PMN's deep and broad capabilities provide a three-dimensional control structure: Centralized Control, Decentralized Operation, and Distributed System Administration. Centralized Control is embodied in a set of rules established by senior management that constrain the scope of employee actions and use of resources. Action and use or resources is typically based on job, responsibility, and the need to perform a system function. Within the scope of these policies and rules, Distributed System Administration allows owners of resources to span the organization. Management assigns an owner to each resource. Owners control deployment and sharing. Decentralized Operation empowers employees to perform all system functions within their defined scope without an intermediary (“chauffer”). Tables supported by user-friendly language facilitate management by technically unsophisticated individuals.

PMN Control Center [1]: Just as Telco Central Offices where subscribers' lines are joined to switching equipment for connecting other subscribers to each other, the PMN Central Control Center [1] provides similar switching services. It also moves redundant features provided by codec manufacturers, and centralizes them in Control Center components. For example, redundant codec features include: gatekeepers, gateways, MCUs, Web, and other communication interfaces. This architectural structure concentrates and focuses MCU and gateway services where they are needed—on multipoint and mixed protocol conferences (e.g., IP and ISDN).

Network Management System (NMS) software [1.12] is the means by which the PMN Control Center controls system operations at the direction of end-users [2.1, 2.4] governed by enterprise management control constraints. For example, NMS, together with the Multimedia Switch, control dynamic switching during conference calls, multicasting, broadcasting, and delivery of video-on-demand services. Since NMS [1.12] is event-driven, it provides real time service to events and multi-user changes of state. NMS handles all device interrupts; interrupts are specific to devices, system interrupts (e.g., scheduler, resource manager), and end-user signaling. To this end, the following are examples of NMS [1.12] interrupt handlers: codec control, video switch control, on demand server control, media control, video bridge control, audio bridge control, audio mixer control, continuous presence (video matrix Multiviewers) multimedia switch control, scheduler control, active speaker control, host and participant signaling control, etc.

PMN's multimedia control system is built upon an audio conferencing platform that is scalable, open, interoperable architecture that conforms to industry-standards (i.e., Signal Computing Systems Architecture, Scbus). NMS' PC-based audio boards are the intersection point between the computer system and the telephone network. Computer Telephony (CT) integration allows computers to take advantage of PBX signaling information via Application Program Interfaces (API). Computers interact with telephone networks in two fundamental ways: 1) the control function controls how calls are established, reconfigured and “torn down”; 2) the media processing function sends and receives information through the call endpoint interface, generating and receiving the appropriate information formats such as facsimile, voice, tones, or data.

The information sent between the PBX and its telephone handsets significantly enhances CT applications by providing call control information (e.g., calling and called number identification). Control signals are transmitted by two methods: 1) Switch-specific in-band signaling uses the same band of frequencies (touchtone) as the audio signal; 2) Switch-specific out-of-band signaling uses separate band of frequencies from the audio signal via serial or ISDN D channel.

To move from audio bridge to full function multimedia, the inventor developed a control architecture composed of 11 hardware and software entities: 1) IP Control [1.1]; 2) Telco IVR and Keypad Control [1.2]; 3) Multipoint Control Unit (MCU) Farm [1.3]; 4) Telco Audio Bridge [1.4]; 5) Devise Manager [1.5]; 6) Network Manager [1.6]; 7) Public Network; [7]; 8) Enterprise Intranet [1.8]; 9) Resource Manager [1.9]; 10) Scheduler [1.10; and 11) Session Manager [1.11]. The PMN Control Center is a combination of off-the-self hardware products and NMS, which is developed software. Many of the services provided by NMS are similar to the services provided by Telco telephone conference vendors: dial the 1^{st} party, connect, hit the telephone plunger, dial the 2^{nd} party, connect, hit the plunger, and continue the process until all parties are connected, and hit the plunger twice and start the conference. Rather than using the computer to initiate the call as videoconferencing vendors, PMN builds upon the Telco model to create a novel multimedia system that is intuitive.

IP Control [1.1] and Telco IVR and Keypad Control [1.2] are the PMN man/machine interface for end-user system service requests to establish and maintain the system management and operational control structure, and setup, control, and teardown sessions. Telco IVR and Keypad Control [1.2] is the preferred embodiment for operational control. NMS is the means by which senior management, the System Administrator, and end-users control, administer, and operate PMN.

Senior management establishes the management control structure. Management Control is the set of rules that govern use of resources. The PMN Business Rules Book is table driven to facilitate matching it to the enterprise management control structure. For example, it identifies the Telco/multimedia devices that individuals are allowed to use (e.g., only equipment in cubicle, office); Are there resource that an individual cannot use (e.g., Continuous Presence Switch [2.2.3]). At log-on, must an individual enter a User ID, password, and project code? Is there a priority system, and levels of “shut-down” for emergencies (e.g., President overrides other end-users)? Can an individual be denied access because of budget overrun (billed for system use)?

The System Administrator uses the IP Client [1.1] to setup (including management controls) and customize the system tables. The System Administrator uses either the IP [1.1] or Telephone Client [1.2] to perform ongoing system maintenance. IP is the preferred embodiment for system maintenance. During daily operations, end-users use either the Telephone [1.1] or IP Client [1.2] to formulate requests for service, enforce system protocols and rules, keep end-users aware of the status of requests, and provide a collaboration environment.

Session types include: Collaboration, Media-On-Demand, Mail (video and voice), Broadcast, Distance Learning, Telemedicine, Court Room, Media Management, Emergency Response; etc. Collaboration could be broken down further into: Join Meeting, Request Schedule, Change Schedule, Arrange Meeting Now with NMS Confirmation, Arrange Meeting Now with Host Confirmation, Schedule Future Meeting, etc.

Format could include: Point-To-Point or Multipoint; Hollywood Squares or Voice Switched Video versus Host or Participant Controlled; Listener Control (permission to audit); Open versus Closed door meetings (permission to join, entry rules when started, ad hoc invitations rules/procedure); local and far-end camera control, Special equipment (e.g., document camera), Special software (e.g., PowerPoint, Whiteboard, Internet), etc. PMN “virtual” meetings provide the same formats and queues used in “live” meetings. For example, host-controlled video switching breaks through the confusion about who is the next speaker. This similar to the host sitting in the room pointing or identifying the next speaker by name. Variants of this are participant-controlled-video-switching by signaling the host to talk to the forum, and camera switching on demand. These options fit a range of meeting formats ranging from structured meeting to brainstorming. However, though meetings seem to be unstructured, they still have an underlying structure. The need for this underlying structure is even more important in virtual meetings.

On balance, our invention differs from contemporary systems because it empowers end-users to gain real-time access to enterprise-wide multimedia services. No “chauffer” is required. Each individual controls delivery of their own services; Services that deliver Boardroom level quality to every desktop as seamlessly as the telephone. Network Management System (NMS), user-friendly, event-driven software, is the means by which senior management, the System Administrator, and end-users control, administer, and operate PMN. PMN provides both loosely coupled and tightly coupled levels of service. In the loosely coupled model, Telco equipment is used as the man/machine interface [1.2]. In contrast, the tightly coupled model provides client desktop software [1.1] that provides an onscreen telephone paradigm (for consistency), as well as object-based on screen visual session control queues and facilities; Queues that are not possible on the telephone-based interface. The loosely coupled system minimizes contact with enterprise computer systems and provides far more flexibility. System resources can be managed from any telephone. In contrast, tightly coupled systems require a PC, and facilitate handling of complex installation and maintenance jobs. By using IP technology [1.1], the system is operated and maintained from a central Internet Web site. End-users' download copies of the PMN Client software during installation, when needed. Depending on experience level, end-users can choose either the Phone Paradigm, or the user-friendlier, Object Paradigm. While using the IP Phone paradigm to control services, end-users become conversant with use of the telephone Phone Client and “type-ahead” data entry. “Type-ahead” entries are displayed on the screen. Both the IP and Phone Clients support the full instruction set, and “type-ahead” data entry for advanced users. Job-aids are also provided to facilitate “type-ahead” data entry. The end-user's profile determines the level of “hand-holding”.

As we discussed, most contemporary systems rely solely on handheld remote control devices; Devices that are an additional cost item. In contrast, the PMN Phone Client uses the enterprise desktop telephone, which serves triple duty: 1) Multimedia Control, 2) Multimedia microphone, and 3) Multimedia speaker. Telephone headsets and speaker telephones are also supported.

Since Private Multimedia Network is designed for enterprise-wide use, NMS provides tables and user-friendly commands that facilitate tailoring the system to fit enterprise management and operational control policies and standards. Senior management establishes the management control structure. Since text and data entry are awkward on a telephone, the IP version is used to for system setup and most maintenance tasks. The System Administrator uses the IP Client [1.1] to setup and customize the system, and either the IP [1.1] or Phone [1.2] Client to perform ongoing system maintenance and operational tasks. However, the Phone Client [1,1], which mirrors telephone conferences, is the preferred embodiment for “immediate” conferences. Depending on complexity, either Phone or IP (more complex) can be used for scheduled conferences.

Multipoint Control Unit (MCU) Farm [1.3] are bridging or switching devices used in support of multipoint videoconferencing, which enables multiple (3 or more) face-to-face conference connections. Once a session is setup, it is possible to add multiple sites (codec end-points [2.2.1, 4.1, 5.1]) to a videoconference call and simultaneously allow several additional locations to participate in the session. Participants can see each other on a screen in a pattern similar to a “Hollywood Squares”.

Telco Audio Bridges [1.4] are cards that fit into computer chassis that serve as a PBX interface. PMN's PBX interface, Interactive Voice Response (IVR), Digital Signaling Processor-based audio conferencing hardware and software transform existing enterprise telephony systems into effective multimedia components. A Private Branch Exchange (PBX) is a privately owned, mini version of a telephone company's central office (CO) switch. The advantage of a PBX is the efficiency and cost gains of sharing a specific number of telephone lines among a large group of users. Key Telephone Systems (KTS) are smaller versions of PBX that give direct access to telephone lines. NMS provides value added service by providing a hybrid multimedia PBX-based conference bridge that delivers the video portion of the conference via premise Multimedia Switch and LAN (and gateway, as needed), and delivers the audio portion via a common audio conferencing bridge and gateway, as needed. Premise delivery of both analog audio and video via the Multimedia LAN is another alternative. Gateways are used for inter-site communication to transmit video signals and synchronize video and audio signals. Conference control (e.g., setup, tear-down) is managed via PBX or POTS telephone-based software. By combining PBX-based telephone and analog-based video, PMN pushes the multimedia envelope to a new level.

Telco Audio Bridge [1.4] embodies PBX call control features (e.g., call answer, call transfer, conference calling, call hold, and call hang-up). When delivering PMN services, the NMS PBX Server strips the enterprise PBX switch [5] of much of its intelligence. Using the enterprise PBX as a “pass-through” intermediary, end-users can perform video conferencing collaboration, gain access to complex information, and invoke complex system features from telephones and workstations controlled by the Telco Server. Telco Audio Bridge [1.4] permits telephone callers from several diverse locations to be connected together for a conference call. Conference bridges contain electronics for amplifying and balancing the conference call so everyone can hear each other and speak to each other. These real-time, multi-party cards support over 500 seats, over 100 ports, and digital trucking. Multiple cards can be placed in a computer chassis. Though not designed for video conferencing, commercial telephony bridges contain programmable API call control features that facilitate implementation of videoconferencing applications: 1) create and delete a conference; 2) active talker status (capability to determine which participant is talking at a given time); 3) coaching mode (the ability to selectively control which conference members can hear chosen participants without the knowledge of other conference members); 4) echo cancellation (prevents disturbing feedback and echoes); 5) data logging (recording full-duplex conference calls); 6) IVR (Interactive Voice Response for management and operational control end-user dialogue-based system settings); 7) Call control setup and tear-down; 8) Real-time faxing and IP voice; 9) T1 and E1 interfaces.

Device Manager [1.5], at the direction of Session Manger [1.11], controls the operation of PMN Control Center [1] and Enterprise Premise [2] hardware. PMN Control Center devices (e.g., Multimedia Control Unit (MCU) [1.3] and Telco Audio Bridge [1.4]) during session setup, operation, and teardown. PMN Control Center devices are either computer cards installed in the Server chassis or directly connected to the Server. Device Manager [1.5] uses the existing enterprise telephone and IP networks [1.8, H] to deliver remote control commands to Premise Control Units [2.2.4]. Premise Control Units are configured and controlled by a variety of protocols (e.g., ARP, UDP, TCP, TFTP, ICMP, HTTP, SNMP, DHCP and Telnet. Control commands conform to vendor hardware APIs and use device appropriate network interface (e.g., RJ45, DB-25), and serial interfaces (e.g., RS232, RS422, RS485). There are many products in the marketplace (e.g., Lantroniox, Digi Connectware) that satisfy PMN Control Unit requirements. The following premise hardware is controlled by Premise Control Units: end-user appliances [2.4.2] and Premise Switching Center [2.2] (on-demand servers [2.2.3.2, FIG. 5 (e.g., Video Server, Cable TV Server), Multimedia Switch [2.2.3, FIG. 5] (e.g., Cross Point Switch, Video Multiviewer (Continuous Presence Engine), Audio Mixer), Premise Codec Farm [2.2.1], and Telephone Hybrid Farm [2.2.2]).

Network Manager [1.6] “manages” the network. Gatekeepers handle address translation (translating complex IP addresses to people-friendly aliases). Gatekeepers also often provide an array of other services such as call routing, call transfer and forwarding, line hunting, LDAP and DNS support, CDR generation (for billing), etc. One or more gatekeepers may reside anywhere on the network, fully integrated into another networking device (such as a gateway) or operating as a standalone software application on a desktop computer. Gateways allow intercommunication between IP networks and legacy networks. They provide transcoding facilities by receiving, for example, an H.320 stream from an ISDN line; converting it to an H.323 stream and sending it to the IP network. Gateways can also perform call setup and clearing on both sides of an IP to switched-circuit connection. As many video conferencing systems are still ISDN-bound, the gateway is likely to continue to be an essential device in any IP centric conferencing network. In IP-based videoconferencing systems, terminals that signal each other directly must have direct access to each other's IP address. Therefore, firewalls and proxies are needed to protect a system from the risk that key information may be exposed over an H.323 network. Products such as Ridgeway allow freedom to exchange information both between enterprise sites, and even between enterprise and foreign sites, without compromising the integrity of its firewall and proxy system and ability to perform network address translations. These products increase the value of PMN. Though PMN could be implemented solely within the walls of the enterprise, we recommend that the Central Control Center sit outside the enterprise, just as a public utility, serving as a common resource to many enterprises. Exceptions include Homeland Security and other government projects that require all system components to be within the walls of the agency for security purposes. Adequate bandwidth and quality of service (QoS) are the final network deployment issues. QoS is the guaranteed quality of the media being delivered. With traditional circuit-switch telephone networks we expect to hear what someone says immediately and without distortion. On a packet network, the guaranteed level of performance depends on a set of transmission parameters such as delay, jitter and bandwidth that is assigned to selected traffic on the network. There are service providers and hardware, software, and procedures (e.g., Bulldog) that deliver quality of service. Lastly, there are seemingly negligible environmental and human factors that often determine the success or failure of a videoconference. These factors include type of terminal, acoustic echo cancellation, lighting, camera quality, background noise, silence suppression, relative position of the camera, screen and participant, and setup time.

Public Networks [1.7] are networks operated by common carriers or telecommunications administrations for the provision of circuit switched, packet switched and leased-line circuits to the public. Just as Enterprise Intranet [1.8], Public Networks typically provide a broader range of communication link services (e.g., IP, ISDN). However, they like the quality of Enterprise Intranets. Network transmission is generally the weakest link in delivery of end-to-end quality.

Enterprise Intranet [1.8] is a private network that uses Intranet software and Internet standards. In essence, an Intranet is a private Internet reserved for use by people who have been given the authority and passwords necessary to use that network. Companies are increasingly using Intranets—internal Web servers—to corporate information and to control transmission quality. Most corporations are moving from ISDN to IP to lower cost and improve quality by shifting to higher bandwidth transmissions. Though PMN supports all ITU compliant network transmission protocols, analog and IP are the preferred embodiments. IP networks are fundamentally different from ISDN networks—legacy technology still used for videoconferencing and related applications. IP networks have a distributed and flexible architecture that spans LAN, WAN and/or Internet. The IP infrastructure is location-and service-provider independent. The inherent scalability of IP allows bandwidth to be increased, equipment to be added and services to be improved without making any fundamental changes to the underlying infrastructure. The Intranet will be provided either by the Enterprise or to the Enterprise by a service provider as a subscription service.

Resource Manager [1.9] keeps track (maintains a calendar and resource inventory) of the location and disposition of all system hardware. and communication facilities. Most importantly, it manages “shared” devices (e.g., Multimedia Switch [2.2.3], Premise Codec Farm [2.2.1], Telephone Hybrid Farm [2.2.2], On-demand Servers [2.2.3.2]). For example, if an enterprise configures a PMN system with “blocked ports” on the Multimedia Switch [2.2.3] (Cross Point Switch), Resource Manager would have to keep track of which session is using the “gateway” path (“nailed-down” circuit) between switch modules (granular switch) or between differing inputs and outputs in an unbalanced switch (e.g., 160 input versus 128 outputs). Blocking is used to allow more ports to be connected to a switch than can be serviced simultaneously. It is based on the assumption that the system will rarely be fully utilized. Other shared resources require similar “share” management. If resources are not available, the end-user is given a “busy” signal.

During the session startup process Resource Manager determines that all resources needed to support the session are available. If they are available and the session is scheduled, Resource Manager reserves all required resources (including end-to-end circuits) from session start to finish. This includes both immediate and future scheduled sessions.

Scheduler [1.10] combined with Resource Manager [1.9], and Phone and Business Rule Books are used by the IP and Telco Clients to schedule and reserve resources required to book a session. Sessions can either be “immediate” or “future”. Session participants can either be confirmed by NMS [1.12] Client [1.11, 1.12] or by the session host (end-user) [2.1]. NMS uses Telco IVR and IP resources, as appropriate. For “future scheduled” meetings, Scheduler sends the host and participants a follow-up email outlining facts about the meeting. The Phone Book identifies the end-user and the class of services and resources that can be used. The Phone and Business Rule Books support dynamic updates. Resources are related to Phone Book entries (owner) as well as physical location (e.g., premise and room) and relationship to other resources (e.g., hardwiring of resources to the Multimedia Switch, or either pool or direct relationship between Codecs and Telephone Hybrids). Ownership implies control (e.g., desktop telephone). Shared Resources are owned by the enterprise. The Phone Book reflects the standard relationships between people and resources. However, PMN allow ad hoc, temporal relationships to be created (e.g., scheduling a future conference using at different location (not office) and using a different telephone. Generally, the new location and telephone and other end-user resources required for the session will be recorded in the Phone Book. However, if they are not and the Business Rule Book permits it, they can be placed in a temporal section of the Phone/Resource book. We will also provide a section in the Phone Book for frequently called numbers (Foreign entities that frequently engage in PMN collaboration sessions with Enterprise staff).

Session Manager [1.11] is responsible for insuring that all resources are available and that session protocol is followed insure proper end-user billing for resources and services rendered. Collaboration (meetings) requires the most support services. Session Manager uses IVR and telephone key pad keys to help the host administer the meeting, as needed (e.g., greet participants and insure that they are in the right room (meeting ID and/or individual's ID), manage “open” and “closed” door meeting rules; answer questions and solve problems, instruct participants on rules and use of services; administer signaling protocol; end meetings on time). Session Manager also administers the waiting room. For example, participants that arrive after a meeting starts are identified to the host off-line (coaching line) of their arrival. The Host determines when they can enter the meeting. IVR and “beep” signals will be used, as needed, to signal changes of state (e.g., beeps as an alternative to IVR to signal that there are participants in the waiting room and the door is closed). Depending on meeting format, during a meeting signals by both participants and hosts maybe allowed. For example, a participant in a conference could “signal” the conference host to request the “floor” (on screen camera coverage in a host-directed-video switching); The session host could signal Session Manager to extend the meeting time. Session Manager could contact the session host to announce an emergency shutdown of the session because of priority override (e.g., “bumped” by CEO). Refer to IP and Telco Client Control [1.1, 1.2] for further discussion of session formats. Special keys on the telephone keypad will be reserved for signaling. The system will also provide an IVR off-line help function to assist individuals that forget.

Enterprise Premise Sites [2,4]: As we discussed in the PMN Overview, Enterprise Sites are broken down into four levels: 1) enterprise premises [2,4]; 2) enterprise campuses (interlocked premise Multimedia Switches [6]; 3) enterprise proximity sites [2,4] (linked by “real-time” trunk lines, e.g., fiber [K]); 4) enterprise geographically dispersed sites [2,4] (linked by non-real-time long-distance services, e.g., IP [Z, Y]). Just as Telco companies, Enterprise sites have both premise and node (desktop) equipment.

PMN Premise Switching Centers [2.2], which consist of: 1) Codec Farm [2.2.1], Telephone Hybrid Farm [2.2.2], Premise Control Unit [2.2.4], and Multimedia Switch [2.2.3], and On-demand Servers [2.2.3.2]. Each premise has one or more PMN Premise Switching Centers. To further facilitate installation, we also provide a “plug-and-play” proprietary, rack-based cabinet on wheels that contains all hardware and software components Premise Switching Center [2.2] components. Customer and service personnel design components for fit, and incremental expansion, mobility, and ease of access. By design, PMN requires no change to existing computer servers and networks. There is only need for existing ports to be provisioned for inter-site communication (e.g. codec-based IP, ISDN, LAN Ethernet, uncompressed fiber).

Premise Codec Farm [2.2.1] codecs, a shared resource, provide digital gateways that transmit video and audio between premises for delivery to end-users by each site's Multimedia Switch [2.2.3] and LAN [2.3]. During transmission, they convert voice and video signals from analog form to digital signals acceptable to digital PBXs, videoconferencing, and other digital transmission systems. After transmission, they then convert digital signals back to analog for phone, audio, video and other analog-based systems. Codecs are end-points that are installed at each collaborator site. As shown in FIG. 3, codecs provide a communication link between Enterprise [2,4] and Foreign [5] site Codec Farms [2.2.1]. If the session is multipoint (more than 2 parties), the communication link is [Z], via the PMN Control Center [1], Multipoint Control Unit (MCU) Farm [1.3]. If the session is point-to-point (2 parties), the communication link is [Y], which is a direct path between codecs at the two sites [2.2.1 and 4.1 and/or 5.1]. Synchronized digital video [A1-C1] and audio [G1] is transmitted between the codecs. At the direction of end-users [2.1], PMN Control Center [1], Resource Manager [1.9] manages codec availability, and the Scheduler [1.10] schedules use.

Rather than deploying expensive codecs and dedicated lines to Boardrooms, meeting rooms, and executive offices, NMS' rack mounted “Codec Farms” [2.2.2] and Multimedia LANs [2.3] facilitate sharing of scarce codec and communication link resources by desktops across the enterprise. The PMN architecture deploys industrial strength codecs as a common shared resource (Codec Farm) rather than deploying low quality codecs at each node. Rack mounted codecs provide much higher quality video and audio than less expensive computer board-based models that suffer from jitter and are deployed in standalone PCs. Once the digital signal reaches the codecs, there is no further loss of quality between the codecs at the premise demarcation point and end-user workstations, as would normally occur as signals travel across data LANs. Uncompressed analog gateways (e.g., fiber, wireless) provide the highest quality end-to-end signal. Resource sharing is the bedrock of the PMN architecture.

Codecs not only support IP, the preferred invention embodiment, they also provide many other costly embedded features: 1) embedded appliances (e.g., microphones, cameras, displays speakers); 2) gateway communication link (e.g., T1 and Ethernet) and protocol services (e.g., IP and ISDN); 3) multipoint control unit (MCU); 4 software wrapper features (e.g., 2-duplex video streams, PC Display/Projector/LAN interfaces, XGA support, encryption, streaming); and 5) Gatekeeper (registration, admission control, address translation, and bandwidth management). Though these functions are necessary, delivered “in-band” and/or co-located not only increases codec cost, in many cases it reduces signal quality, limits bandwidth, and can result in communication link bottlenecks. When codecs are used in conferences, embedded features (e.g., MCUs) are not available for use in other conferences. The converse is also true. When embedded MCU cascading is used to support multipoint conferences, the codecs are not available for other conferences.

Though these products exist in the marketplace (e.g., Tandberg, Polycom), the PMN architecture is novel. Since IP networks provide in-band video and audio, Telco Audio Bridge [1.4] out-of-band technology, a preferred invention embodiment, is not used by any vendor. As shown in FIG. 3, the PMN architectural approach is to move codecs away from desktops and out of meeting rooms, strip them of extraneous (non-codec) capabilities, and place them in Premise Switching Centers [2.2].

Telephone Hybrid Farm [2.2.2] serves as a middleman between analog “real-time”, audio and digital “latent” audio. The Telephone Hybrid sits on both the input and output sides of this transaction, and interfaces with a codec [2.2.1] at each premise. On the input side, it provides Telco Audio Bridge audio to the codec for synchronization via the codec network. On the output side, it takes synchronized codec analog audio output at each premise and delivers it to the Telco Audio Bridge [1.4]. The this novel way, PMN uses premise Hybrid Telephones [2.2.2], codecs [2.2.1], and MCUs [1.3] to overcome IP, Ethernet, T1, and ISDN gateway latency-based lip-synching problems. The architecture also makes it possible to centralize Telco bridges and use existing desktop telephones and other Telco appliances rather than microphones and speaker systems for delivery of conference audio. FIGS. 6-11 demonstrate how this structure supports full service delivery of conference services. Audio is 40% to 50% of the cost of provisioning a videoconferencing system or variant thereof. Telephone Hybrids (e.g., Telos) are off-the-shelf devices used by Radio Broadcasters to interface analog and digital systems.

Multimedia Switch [2.2.3], a shared resource, are commercially available devices (e.g., PESA, Ademco, Extron) composed of high-density building blocks suitable for creating very large, non-blocking, Cross-point arrays; Arrays that fit the needs of small offices to large campuses. Under Session Manager [1.11] and Device Manager [1.5, 2.2.4], as shown in FIG. 5, they control dynamic switching of shared resources (e.g., Continuous Presence Engines, Audio Mixers, Codecs, On-demand Servers, and end-user appliances [2.4.2] during sessions (e.g., conference calls, multicasting, broadcasting, and delivery of video-on-demand service). Continuous Presence Engines are video Multiviewers, and when used in combination with Multimedia Switches serve as video MCUs that enable the simultaneous display of multiple video sources in real time; e.g., 4 inputs to 1 output with 4 quadrant display); Audio Mixers are similar to audio bridges, and when used in combination with Multimedia Switches, serve as audio MCUs that combine multiple audio inputs for playback on a single speaker system; e.g., 4 inputs to 1 mixed output). Multimedia nodes are predefined. As shown in FIG. 5, the low-end nodes are reserved for shared resources (e.g., trunk lines, on-demand servers, audio and video bridges, codecs, and data recorders (use for Home Land Security and not shown on FIG. 5), and the upper nodes are used for transceivers that connect via the Multimedia LAN [2.3] to end-user nodes [2.4]. Multimedia Switch capacity is determined by end-user node requirements and shared resource input and output requirements.

The Multimedia Switch controls the flow of multimedia (video and audio) information throughout the system. The switch exchanges multimedia information with enterprise premise sites via trunk lines [H] and foreign [5] (outside the enterprise) and other enterprise conferees [2 and 4] via the Codec Farm [1.4] and Intranet [1.8] (e.g., IP, T1, ISDN) or the Public Network [1.7]. Just as with telephone systems, the switch manages the movement of multimedia information both between nodes within the premise, and between nodes in the premise with external nodes, as needed. The Multimedia LAN [2.3] delivers multimedia between end-user nodes [2.4.1] and the Multimedia Switch. To gain better resource utilization, some system users may choose to configure Multimedia Switches with “blocked” ports (more inputs than outputs). Surveillance systems are often configured as “unbalanced” switches. When configured in this way an end-user could get a “busy signal”.

On-Demand Servers [2.2.3.2] provide a platform for end-users to use the Telco and Keypad Control [1.2] and IP Control [1.1] to request IP film strips, training materials or reference materials and timely business updates (e.g., Bloomberg), multimedia documents, live radio and cable TV, and dynamic management of multimedia resource deployment across the enterprise. etc., from system repositories. As shown in FIG. 5, On-demand Servers are directly connected to Multimedia Switch [2.2.3] input and/or output nodes, as appropriate for device.

Head-in Hub and Transceivers [2.2.3.1] are “plug-and-play”. As shown in FIG. 5, though head-in installation is complex, system component port connections are predefined (refer to Multimedia Switch [2.2.3]. The Head-in Hub provides “plug-and-play” connectivity between Head-in transceivers and the Multimedia LAN [2.3]. There are transceivers in the marketplace (e.g., Extron, ) that can send analog multimedia information across existing enterprise UTP infrastructures for distances approaching two miles. Many also offer signal extenders that can amplify signals to extend longer than distances. These transceivers provide both simplex and duplex, and video only and video and audio services. These devices also offer a wide range of video and audio quality.

Our proprietary Hub [2.2.3.1] splits the Enterprise LAN or telephone head-in hub by separating the two pair used for data from the two pair that PMN uses for multimedia (hereinafter referred to as the Multimedia LAN pair). At the node termination points of each line, two standard RJ45 splitters are used for each Enterprise LAN node (input and output). Normal enterprise LAN and telephone cables can be used to make the connections. We provide custom patch cables, as needed. For each node, a patch cable is plugged between the Enterprise LAN Termination HUB and Multimedia HUB Input. A patch cable is also connected between the Enterprise Network Hub and the corresponding Multimedia Hub Output. During installation, the wrapped set of halves emanating from the back of the panel (a cable for each Enterprise LAN node) is plugged into corresponding nodes on the Multimedia Center, head-in transceivers. All cables (outbound modulator and inbound demodulator) are labeled and color-coded. Corresponding signal splitters are provided at each node for outbound modulation and inbound demodulation.

To further facilitate installation, we also provide a “plug-and-play” proprietary, rack-based cabinet on wheels that contains all head-in PMN Switching Center hardware and components [2.2]. Customer and service personnel design components for fit, and incremental expansion, mobility, and ease of access.

Multimedia LAN [2.3] provides a communication link between end-user nodes and the Multimedia Switch. Transceivers terminate both ends of the LAN. Twisted Pair Transceivers [2.1.1, 2.2.3] send analog multimedia information across the existing enterprise UTP infrastructure for distances approaching two miles Duplex service is provided and analog video [A-C] and audio (optional) [G] are transmitted across the LAN. Existing dark data LAN or telephone twisted pair wirelines are used, and do not impact adjacent applications. PMN's capabilities are not limited to point-to-point (P->P) and multipoint (M<->M). videoconferencing. PMN's ubiquitous and interoperable multi-site architecture delivers a full range of simplex and duplex multimedia services to desktops, meeting rooms, and executive suites. As described in “Brief Description of the Invention”, PMN communication links deliver ubiquitous services; For example: 1) Multimedia On-demand and Monitoring [S] 1 to 1 simplex (P<-P) applications, e.g., cable TV, steaming media; 3) Video and Voice Mail [R] 1 to 1 simplex (P->P); 4) Collaboration [Q] 1 to 1 duplex (P<->P); 5) Broadcast, Advertising, Device Control, and Video and Voice Mail [V] 1 to Many simplex (P->M); 5) Surveillance [U] Many to 1 simplex (P<-M); 6) Distance Learning [T] 1 to Many duplex (P<->M); 7) Telemedicine [P] Many to 1 duplex (M<->1) 8) Collaboration [W] Many to Many duplex (M<->M).

Node Hubs and Transceivers [2.4.1] are “plug-and-play” hubs for end-user appliances [2.4.2]. In typical installations, only analog video is transmitted between the Multimedia switch [2.2.3] and end-user node locations [2.4, 2.1] via the Multimedia LAN [2.3] and LAN termination transceivers. An Appliance Hub (splitter) is provided at each node [2.4.1] to isolate the analog video signal. If computers are used, a TV video capture card is used to display video on the computer screen. If TVs are used, an interconnect cable is connected between the splitter and the TV video in. Optionally, CD quality audio [G] can be transmitted with the video. An interconnect cable is connected between the splitter and speakers. In this configuration, in addition to video cameras, speakers, and a microphone are needed. If the Telco audio option is selected, audio is provided via telephone [G3]. Telco IVR/Keypad Control [1.2] is used for session setup and maintenance Optionally, IP Control [1.1] can be used. Telephones are not interconnected to Room Hubs and transceivers.

Often, the downside of an elegant solution is inherent complexity and provisioning and deployment difficulty. Since PMN logic and wiring is predefined, installation and operation are virtually “plug-and-play.” Desktop installation only requires splitters to be installed on existing twisted pair wirelines (e.g. LAN, Telco) to separate the pairs used for data or Telco from the dark pairs used for PMN video. The video transceiver RJ45 input port is then connected to the PMN video splitter RJ45 output port, and the transceiver composite video output port (typically RCA or BNC) is connected to a TV or PC video tuner card input composite port (typically RCA). Video splitters, and PC video turner cards for PC inboard installation and external use are available in the marketplace. A standard high-resolution videoconferencing camera's composite output (typically RCA) is then connected to the transceiver composite video input port (typically RCA or BNC). The camera's S-video output is connected to the TV or PC video tuner card S-video input port to allow the conferee to see themselves during the conference either in “picture-in-picture” or switched input format. TVs and PC video cards exist in the marketplace with both capabilities. Existing Telco appliances (e.g., handsets and other related) provide microphone and speaker audio.

PMN also supports contemporary multimedia audio mediums (microphones and speaker systems). Microphone ports, typically XLR, are connected to voice preamplifier input ports. Preamplifier output is then connected to transceiver audio input ports, typically XLR. Powered speaker analog input ports, typically RCA, are connected to transceiver audio output ports, typically XLR or RCA.

End-user Appliances [2.4.2] are hardware devices that facilitate use of PMN services. Just as an electric utility does not limit appliance selection, PMN is plug compatible with all standard AV equipment. With PMN there is no need to sacrifice quality for ubiquity or purchase embedded features that inflate price but go unused. Appliances range from projection systems, plasma displays and audiophile sound and camera systems for Boardrooms; to large LCDs for executive suites; to conventional large screen TVs and high fidelity speakerphones for conference rooms; to existing telephones and monitors for desktops. Even cell telephones and laptops (video) can be used. Furthermore, VCRs and personal recorders can also be used locally or as an enterprise-wide resource to record important conferences, presentations, and events. Since we can employ Multiviewer and capabilities and projectors in conference rooms, Whiteboards, PowerPoint Presentations, Streaming Media, and Document Cameras, etc. can be placed in separate windows. These services are synchronized and delivered by Codecs or by Microsoft Office and the Internet. Just as with conference room presentations, the conference host or their designee controls audio/visual timing, content, and positioning.

Appliances and applications are only limited by ones imagination. Though PMN uses Telco audio for mainstream applications; PMN also provides broadcast quality stereo audio that satisfies the needs of the most demanding venues and applications. Since PMN supports mixed audio, only special venues need be configured for audiophile audio. Just as furniture and office appointments, videoconferencing appliances can be scaled to employee position, and individual and group applications.

End-users [2.1, 2.4], in the preferred embodiment, use the Telco Client [1.2] to issue real-time commands to the PMN Switching Center [2.2 and FIG. 5], to establish, operate, and “tear-down” sessions. During daily operation, the Telco and IP Clients help end-users formulate request for service, enforce system protocols and rule, keep end-users aware of the status of requests, and provide a collaboration environment. The NMS Server [1.12] executes and carries out end-user requests by mobilizing and managing system resources (e.g., multimedia switch, codecs, streaming media) and desktop, conference room, and executive suite end-user appliances (e.g., telephones, cameras, TVs). The following operational scenarios are intended to demonstrate how man/machine interface commands (e.g., Telephone Client), systems functions (e.g., resource manager, scheduler, device manager), and information flow through architecture components described in FIGS. 2-5.

The novel way that NMS uses premise Hybrid Telephones and Codecs to overcome IP, Ethernet, T1, and ISDN gateway latency-based lip-synching problems makes it possible to centralize Telco bridges and use existing desktop telephones and other Telco appliances rather than microphones and speaker systems for delivery of conference audio. FIGS. 6 to 11 demonstrates how this structure supports full service delivery of conference services. Audio is 40% to 50% of the cost of provisioning a videoconferencing system or variant thereof.

FIGS. 6 through 11 depict Telco-based collaboration (control and audio) information flow against a backdrop of various types of session service requests and logistics: 1) Single site point-to-point; 2) Single site multiparty voice switched video; 3) Single site multiparty continuous presence; 4) Single site, multiparty, continuous presence and voice switched video; 5) Multisite point-to-point; 6) Multisite, multiparty, voice switched video; 6) Multisite, multiparty, continuous presence; 7) Multisite, multiparty, continuous presence and voice switched video. Telco-based collaboration is the preferred embodiment.

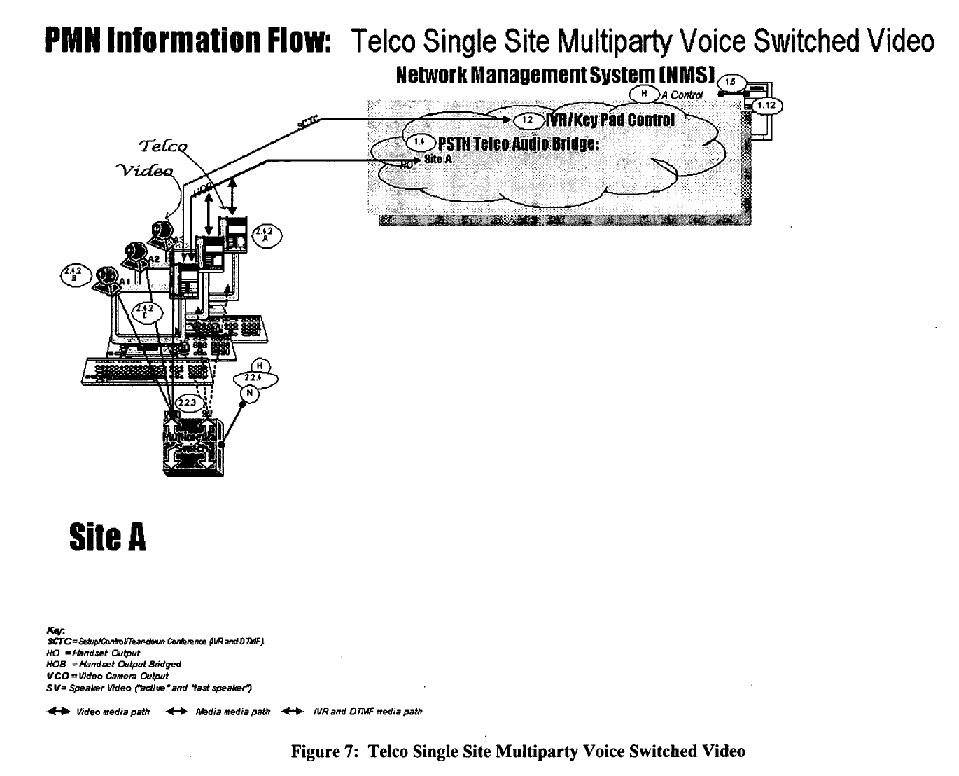

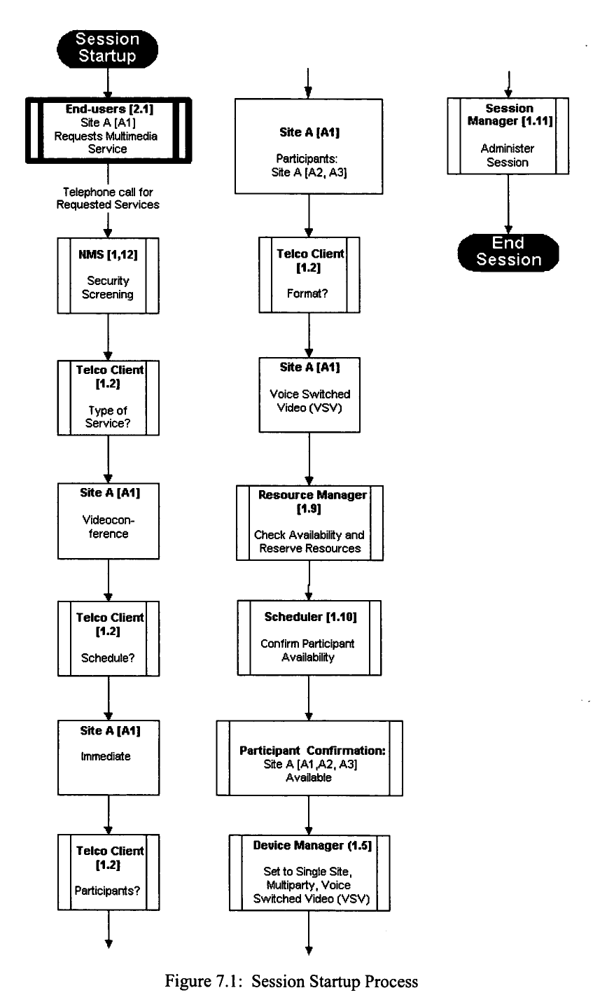

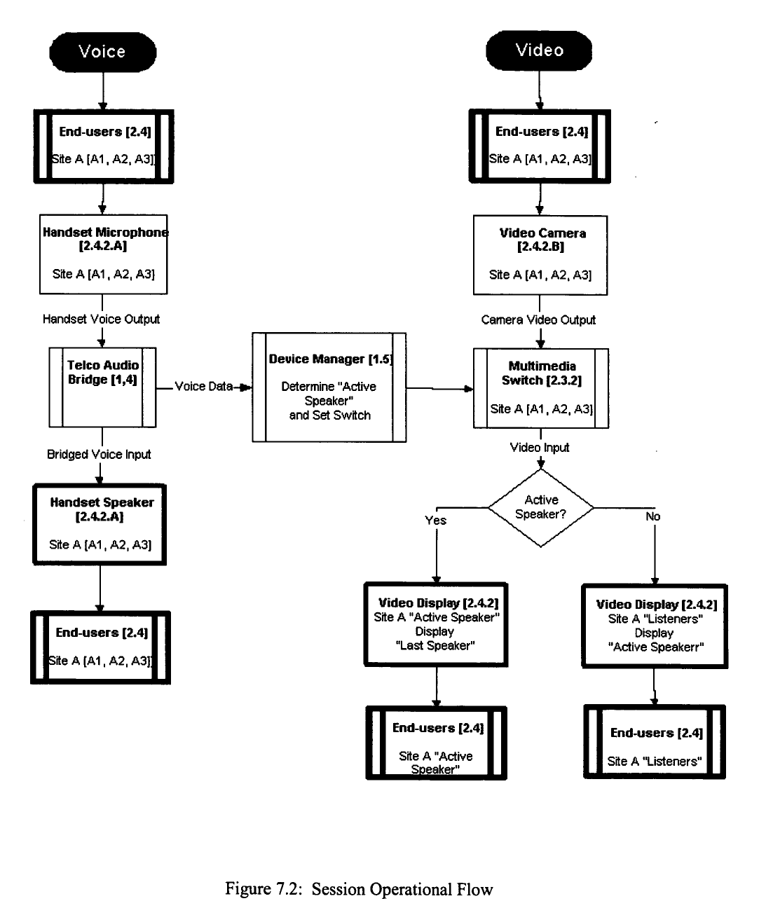

FIG. 7 is a diagram of the PMN Information Flow from a Telco perspective. This diagram focuses on Single Site Multiparty Voice Switched Video. In this diagram, 3 locations [A1-3] in Site A want to engage in a videoconferencing session. Using an existing telephone, the end-user at Node A calls the PMN Control Center 800 number (in Control Center is inside the Enterprise, a PBX extension) to request videoconferencing service with 2 other end-users at his premise. The PMN Telco Client, IVR and Keypad Control [2.4.2.A], provides interactive support to the end-user to set-up, control, and teardown a conference [SCTC communication link]. Telco Client provides the following services: session manager, scheduler, resource manager, and network manager. Either the conference host or Telco Client can call the other participants and request their attendance at the conference at the “virtual meeting” (Telco Audio Bridge [1.4]). The conference can be scheduled to occur immediately or at a future date and time. NMS [1.12] makes sure that all required resources with proper device settings [H, 2.2.4, N] are available for the conference. Since the conference is intra-site, no audio/video synchronization is required. Desktop telephone handset microphone (audio) output [HO] is input to the Telco Audio Bridge [1.4] and Telco Audio Bridged audio output [HOB] is input to the telephone handset [2.4.2.A]. Desktop video cameras [2.4.2.B] are used to deliver end-user video camera output [VCO] to the Multimedia Switch [2.2.3]. Using the Audio Bridge [1.4], NMS [1.12] performs ongoing speaker volume tests to determine the active speaker. Real-time, NMS, via Device Manager [1.5], directs [H, 2.2.4,N] the Multimedia Switch [2.2.3] to send the video for the active speaker [SV] to all conferee displays [2.4.2.C], except the active speaker's display. The current active speaker continues to view the video of the last active speaker until the next change of video. Centralizing the Telco Audio Bridge [1.4] facilitates timely volume testing and switching. At the end of the meeting, either the host requests the Telco Client to end the meeting or the meeting “times-out.” NMS [1.12] then releases the resources for use by other sessions.

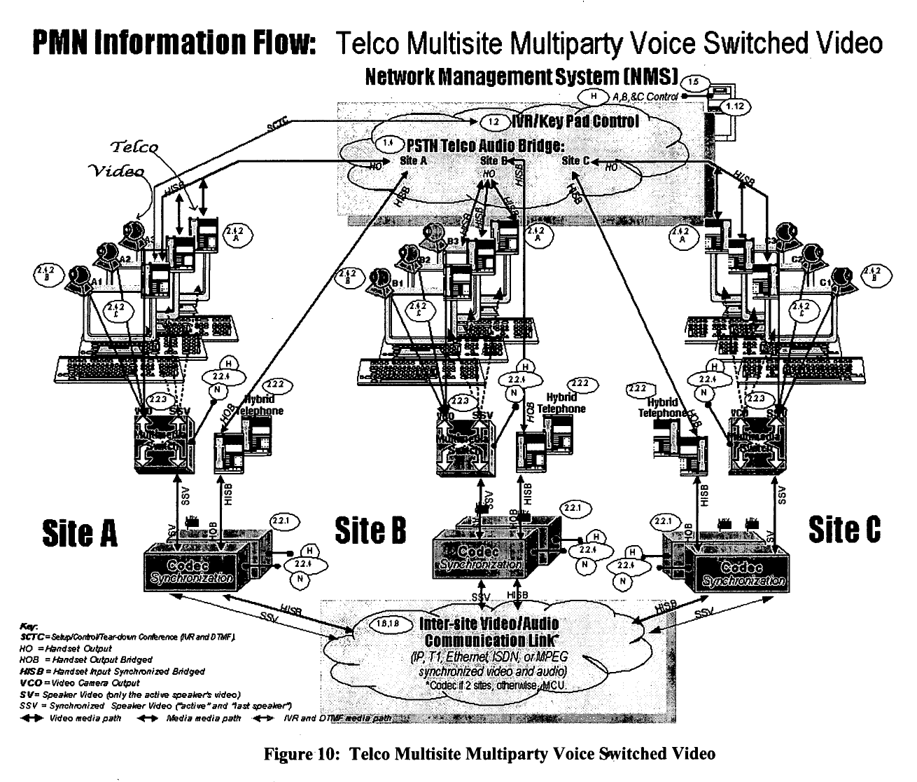

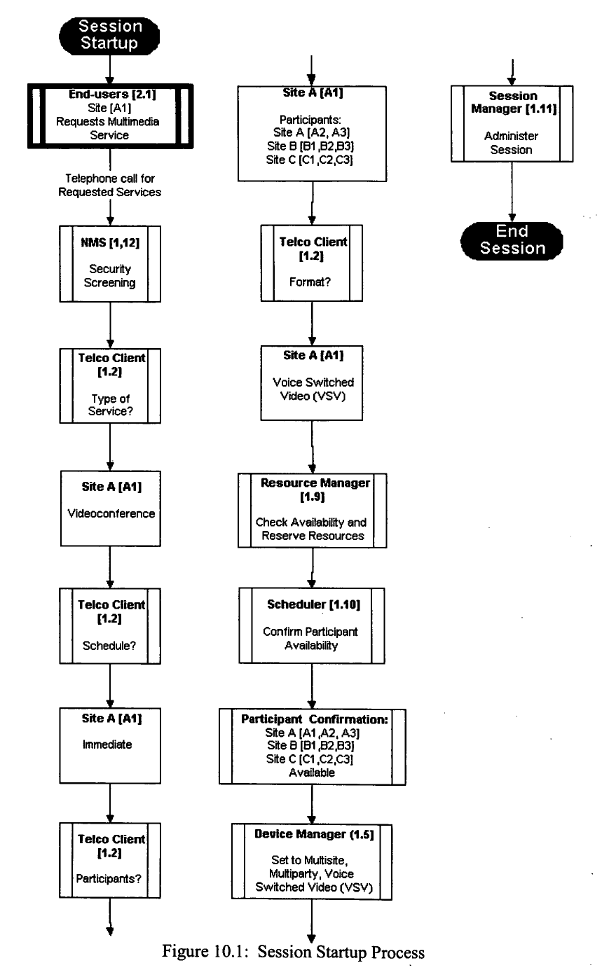

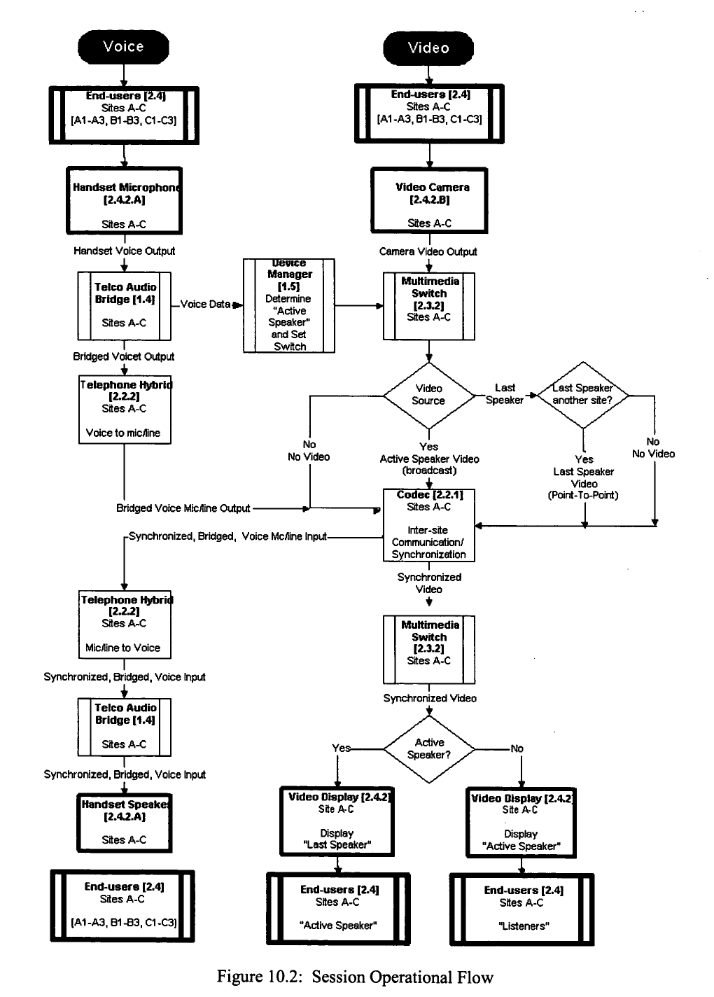

FIG. 10 is a variant of FIG. 7. FIG. 10 focuses on Multi-site Multiparty Voice Switched Video. Rather than one site and 3 conferees, in FIG. 7 we have 3 sites [A, B, and C] and 9 conferees. Since the scenario is multi-site, it is necessary to synchronize video and audio moving between the 3 sites via codec [2.2.1]. Each site [A, B, C] also has an audio bridge [1.4], and the synchronization process is repeated for each site. NMS [1.12] uses the codecs to synchronize video [SSV] and audio [SV]. Telephone Hybrids are middlemen in the audio synchronization process, converting codec line/mike input/output to Telco voice, and vice versa. On the codec side, to synchronize audio, each site's codec [2.2.1] outputs synchronized handset input audio (speaker) to a Telephone Hybrid [2.2.2], and the Telephone Hybrid outputs handset output (mike) to the codec for synchronization. On the conference bridge side [1.4], the Telephone Hybrid [2.2.2] outputs synchronized handset input audio (speaker) to the conference bridge [1.4] for communication to the end-user's headset speaker, and the conference bridge [1.4] outputs bridged handset output (mike) to the Telephone Hybrid. Once audio is synchronized, determination and selection of the active speaker for video switching is similar to FIG. 7. Just as FIG. 7, the Audio Bridge [1.4] with the telephone handset microphone unsynchronized output [HOB] is used to determine the active speaker. The active speaker's video is then delivered to the relevant Site's [A, B, C] codec [2.2.1] via the site's Multimedia Switch [2.2.3] for synchronization and transmission. Just as with FIG. 7, NMS [1.12] via Device Manager [1.5] directs [H, 2.2.4,N] the Multimedia Switch [2.2.3] to send the video for the active speaker [SV] to all conferee displays [2.4.3.C], except the active speaker's display. The current active speaker continues to view the video of the last active speaker until the next change of video.

FIG. 6 is also a variant of FIG. 7. FIG. 6 focuses on a Single Site Point-To-Point scenario. In contrast to Multiparty, since there are only two conferees, no voice switching and conference bridge [1.4] is required. Since the two conferees are at the same site, they share a common Multimedia Switch [2.2.3]. NMS directs Device Manager [1.5] to switch the call to the other conferee's line, and establish a “nailed-down” Multimedia Switch [2.2.3] connection between the two conferees at startup. Multimedia Switch [2.2.3] input and output ports remain in place until the conference is terminated (torn-down)].

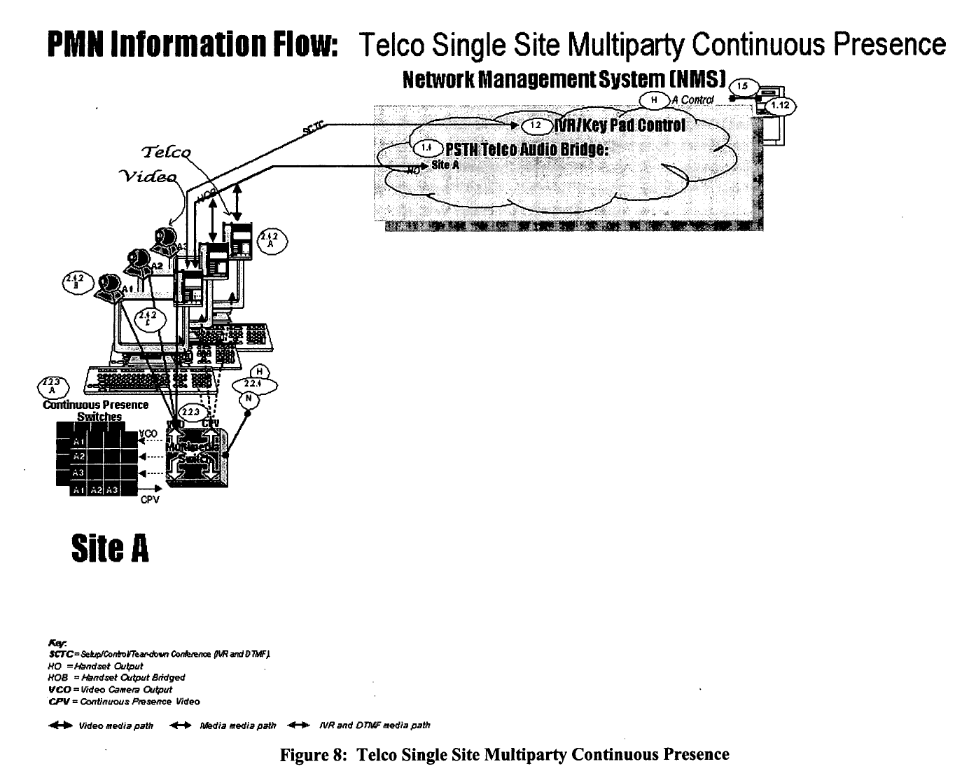

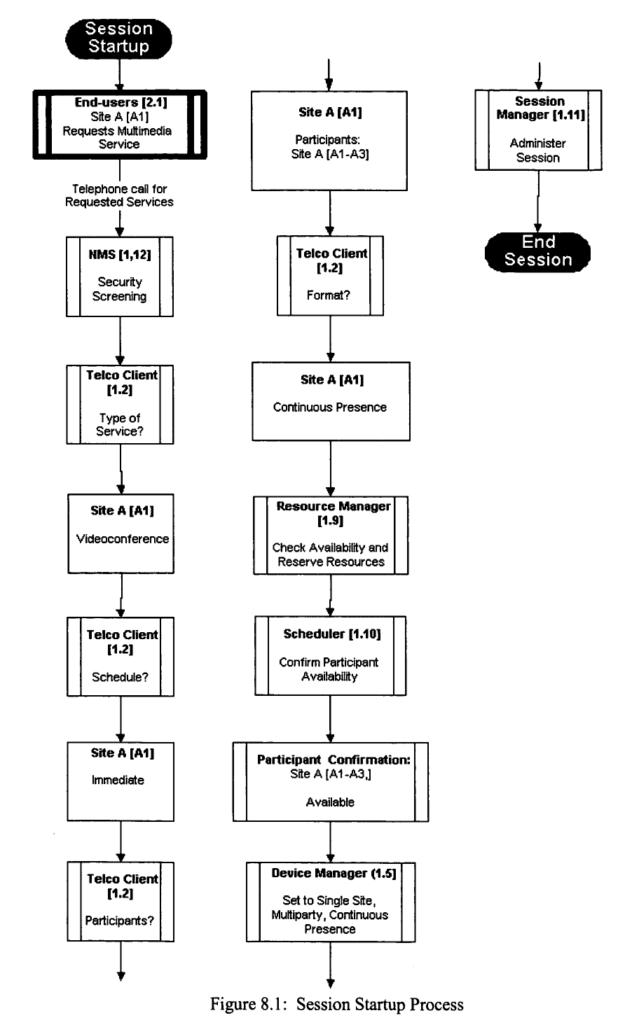

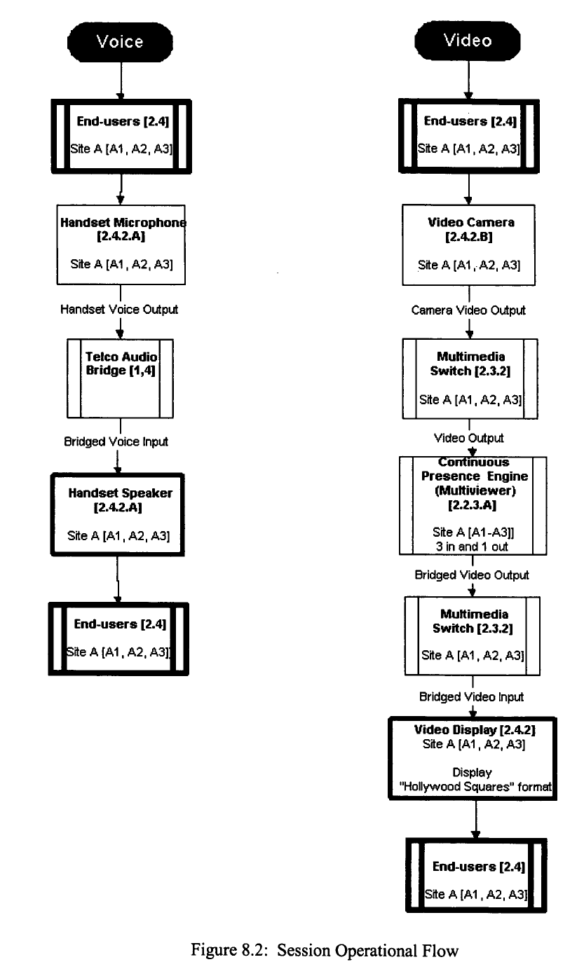

FIG. 8 is a variant of FIGS. 6 and 7. FIG. 8 focuses on Single Site Multiparty Continuous Presence. FIG. 8 introduces the Continuous Presence Engine [2.2.3.A] into the configuration. The Audio Bridge [1.4] receives (handset mike output) and sends (handset bridged speaker output) from/to conferees. However, in this configuration, there is no need to determine the active speaker. Rather than the active speaker, the output [CPV] of the Continuous Presence Engine [2.2.3.A] is transmitted to each conferee continuously via the Multimedia Switch [2.2.3]. Just as FIG. 6, NMS [1.12] “nails-down” the Multimedia Switch [2.2.3] port settings at conference start-up. The Multimedia Switch [2.2.3] connections remain in place until the conference is terminated (torn-down).

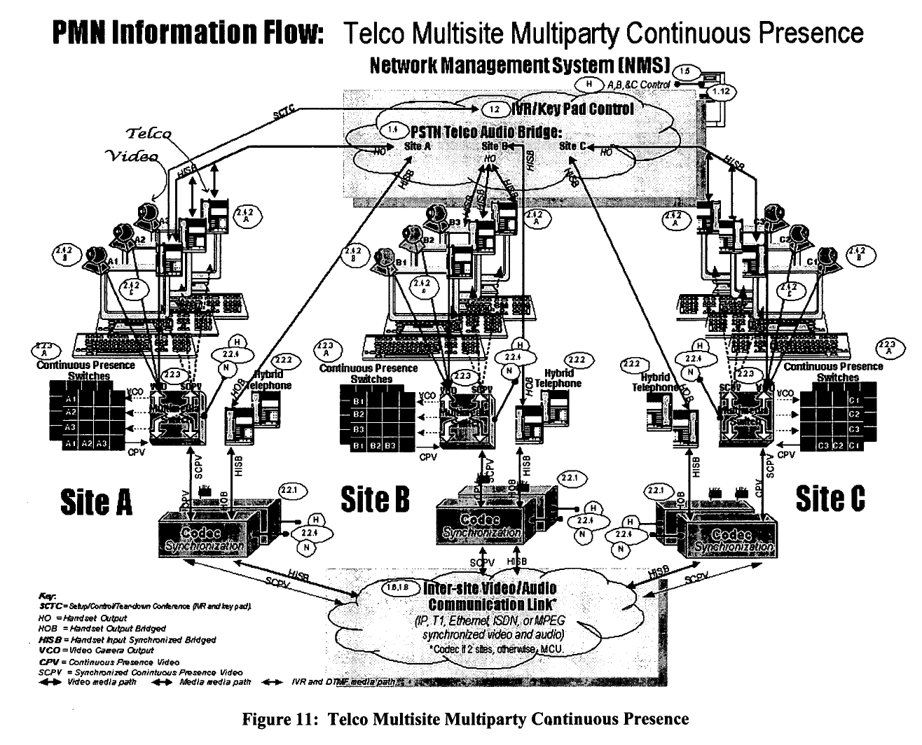

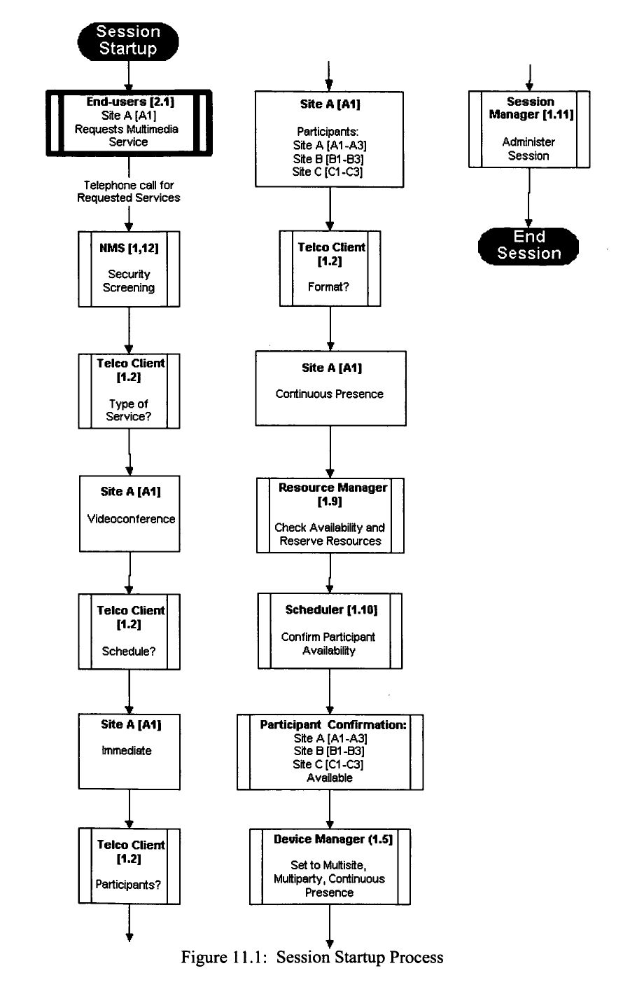

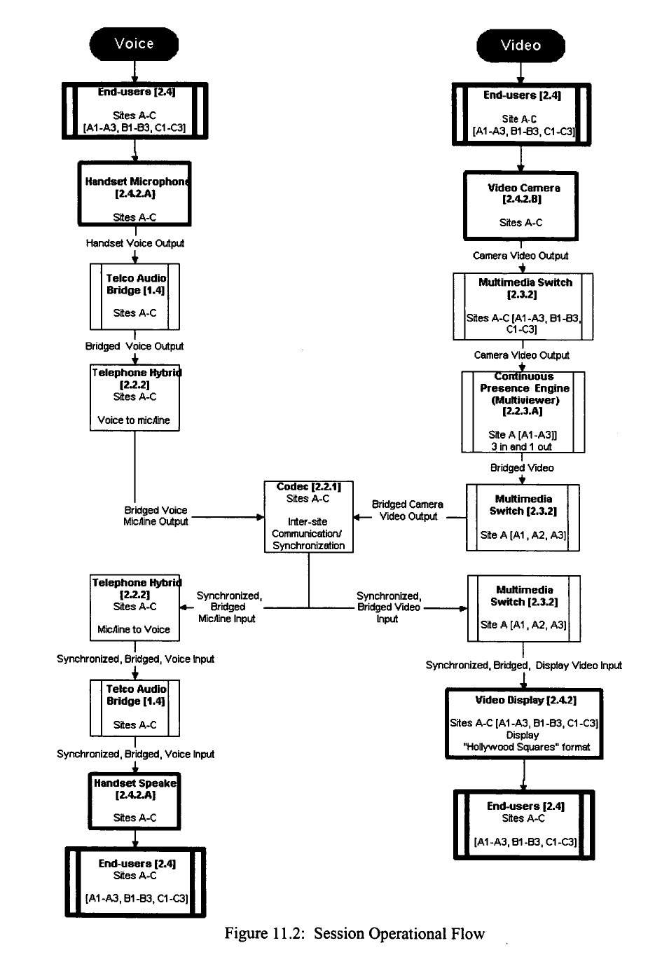

FIG. 11 is a variant of FIGS. 8 and 10. FIG. 11 focuses on Multi-site Multiparty Continuous Presence. The handling of conference control, and audio bridging and video and audio synchronization are the same as FIG. 10. However, since the video is continuous presence rather than voice switched video, video is handled similar to FIG. 8. The output of each Site's [A, B, C] Continuous Presence Engine [2.2.3.A] (combined video from the 3 conferees) [CPV] is transmitted to each Site's Multimedia Switch [2.2.3]. Multimedia Switch output [CPV] is then transmitted to the Site's codec [2.2.1] for synchronization. Then, just as FIG. 10, each Site's [A, B, C] Codec [2.2.1] transmits synchronized video to the Site's Multimedia Switch [2.2.1], and then, to the desktop display [2.4.2.C]. Since the video in continuous presence, just as FIG. 8, NMS [1.12] “nails-down” the Multimedia Switch [2.2.3] port settings at conference start-up. The Multimedia Switch port settings remain in place until the conference is terminated (torn-down).

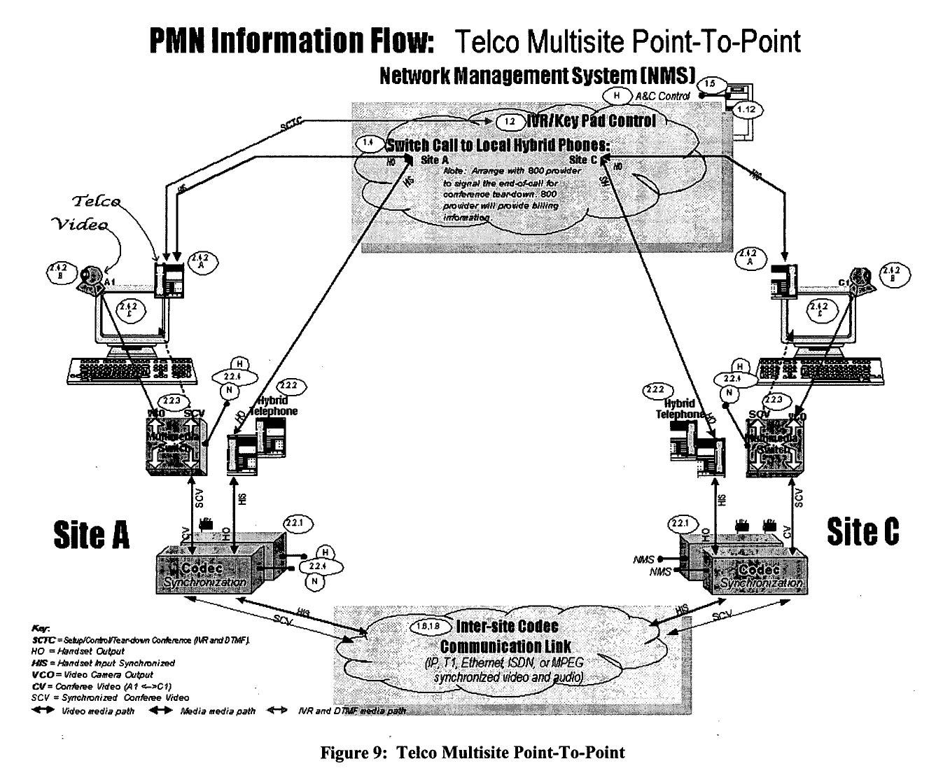

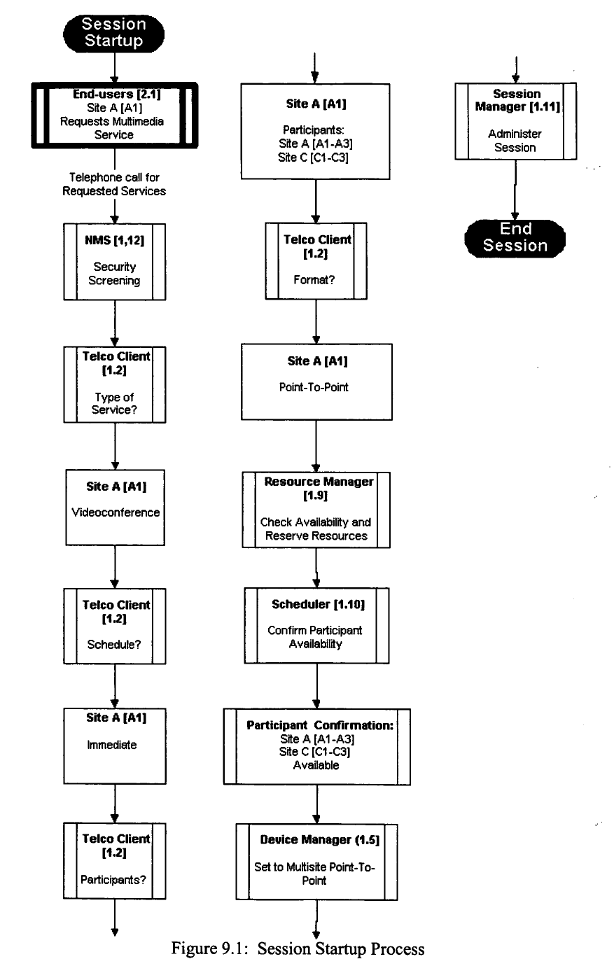

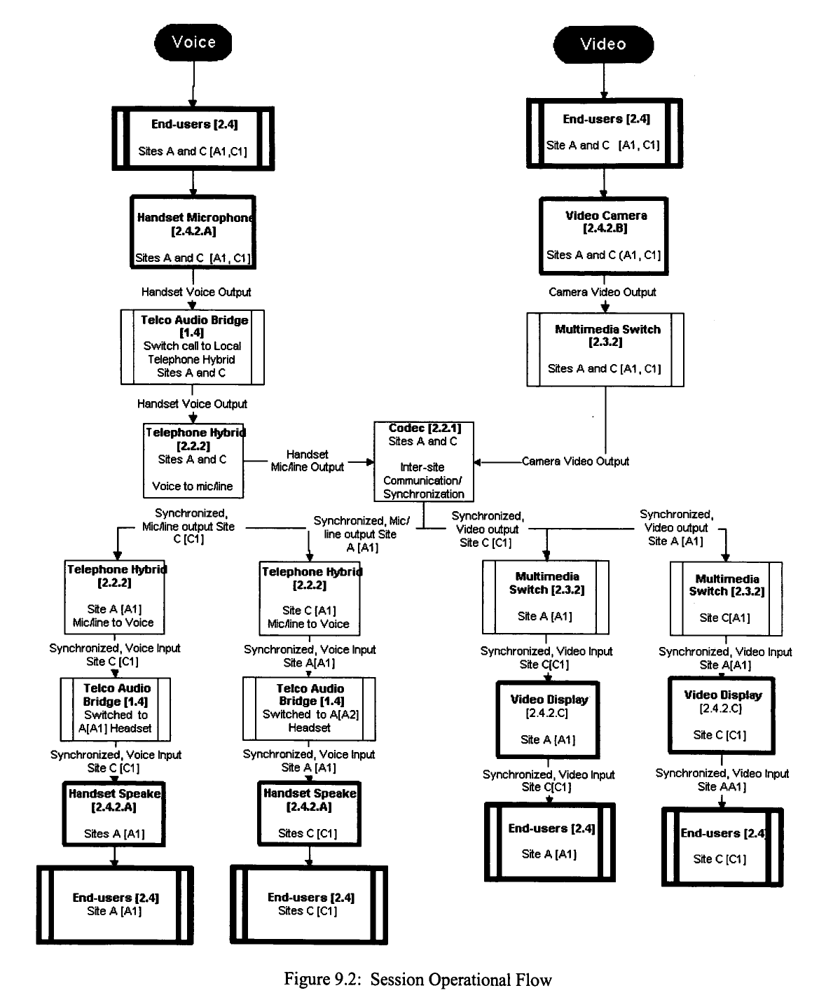

FIG. 9 is a variant of FIGS. 6 and 11. Rather than single site, FIG. 8 focuses on Multi-site Point-To-Point. The primary difference between the two scenarios is “multi-site”. Therefore, just as FIG. 11, the Site codecs [2.2.1] and attendant Hybrid Telephones [2.2.2] must be used to synchronize video and audio. However, since there are only two conferees, just as FIG. 6, no audio bridge [1.4] is required. NMS [1.12] switches each conferee's handset mike output to the other conferee's handset input (speaker). In contrast, just as FIG. 11, each Site's [A, C] codec [2.2.1] transmits its Site's synchronized video to the other site's codec (Site A 's video is transmitted to B and Site B's video is transmitted to A). Then each site's [A, C] Multimedia Switch [2.2.1] displays the other Site's synchronized video on their display [2.4.2.C]. Multimedia Switch [2.2.3] input and output ports remain in place until the conference is terminated (torn-down)].

FIG. 5 is a diagram of an example of a PMN Premise Switching Center configuration and operation. The Multimedia Switch [2.2.3] is common to all diagrams and scenarios. The Multimedia Switch [2.2.3] is an analog cross-point “many-to-many” switch that allows all input ports to be switched to all output ports. The Switch determines the flow of multimedia (video and, optionally, audio) information throughout the system. In most cases, the switching logic is pre-defined and nailed-down at the start of the conference. FIG. 5 shows an example of how a Multimedia Switch could be configured. Typically, the low-end of the switch is populated by devices with shared resources: Analog Trunk Line (output port 0 and input port), Continuous Presence Engine (output ports 1-4 and input port 1); Audio Mixer (output ports 5-8 and input port 2); Codec (output ports 9-10 and input ports 3 and 4); Video Blanking (input port 5); Video Server (input port 6); and Cable TV (input ports 7-9). The desktop end-user nodes populate ports 11 to 16 or the top of the switch. A transceiver (video and, optionally, audio) is connected to corresponding input and output ports.

The Multimedia Switch [2.2.3] depicted in FIG. 5 is configured to deliver the following conference services: 1) end-user Nodes 11, 12, and 13 are engaged in an Intra-site, CD-Quality Audio (microphones and speakers), Multiparty, Continuous Presence conference; 2) end-user Node 14 requests the TV channel on port 9; 3) end-user Node 15 is engaged in a Telco-Quality Audio (telephone), Point-To-Point conference with an off-Site conferee via the Uncompressed Analog Trunk Line (e.g., fiber); 4) end-user Node 16 is engaged in a Telco-Quality Audio (telephone), Point-To-Point conference with an off-site conferee via the Codec.

Multimedia cross-point switches are scalable to fit organizations of varying size, and provide a migration path for growth. Since they provide a communication interface, they can be controlled remotely and require no local PC.

The above exemplary embodiment describes the best mode of making and using the invention known by me at this time. The exemplary embodiment is provided in satisfaction of the statutory duties of best mode disclosure and enablement. However, there are numerous other embodiments possible; For example, operational scenarios for microphones and speakers, or broadcast and distance learning, or Homeland Security. Accordingly, the claims below are intended to have, and should have, a broad range of equivalents and to be limited only by the prior art. cm I claim:

1. An interoperable multimedia architecture that combines hardware, software, and communications technologies that together provide intuitive system management, synchronize diverse real-time and non-real-time transmission means, and deliver isochronous NTSC TV quality or better video and lip-synchronized audio and video to and between a plurality of enterprise end-user terminals and devices that are participating in multimedia sessions between a plurality of enterprise and foreign site participants.

2. The method of claim 1, wherein the Private Multimedia Network architecture and components thereof conform to industry multimedia standards (e.g., ITU, IETF, ISO, MPEGIF), thereby providing worldwide industry interoperability between both Enterprise (inside the Enterprise) and Foreign (outside the Enterprise) multimedia products. Products that adhere to these standards allow users to participate in multimedia sessions (e.g., videoconferencing) regardless of their platform. The ITU has developed the H, G, and T series standards and the IETF has developed Real-Time Protocol (RTP), Real-Time Control Protocol (RTCP) and Resource Reservation Protocol (RSVP). For example, ITU multimedia standards include: Transport Protocols (TCP, UDP, RTP), Transport Media (ISDN, LAN, WAN, Internet, ADSL, VPN), ISDN (H.320), and LAN, Internet, VPN, and ADSL (H.323).

3. The claim 1 architecture comprises the following definitions for terms, end-user venues, site types, connectivity, and service levels:
(a) “administrator session” is defined as a set of management control and system management actives to govern PMN operation. Administrator sessions are 2-levels with corresponding security clearances: a) policy setting to insure that resources are obtained, protected, and used effectively and efficiently in the accomplishment of the organization's goals (e.g., budget and service conformance reporting, “transfer priced” services, long distance call restrictions, logon scenarios requiring not only USER IDs and passwords, but also project codes; Priority overrides for emergencies and senior management imperatives. security policy); b) system management (e.g., system configuration and control table maintenance, and use of Network Manager to monitor and manage the PMN Network.;
(b) “business rule book” is defined as the central repository for PMN business rules. It is structured (table driven) to capture and maintain relevant enterprise management control rules that govern the deployment, use, billing, and security of resources. For example, it identifies the multimedia devices that individuals are allowed to use (e.g., only equipment in their cubicle or office). Are there resources that an individual cannot use (e.g., Continuous Presence Multiviewer Switches)? At log-on, must an individual enter a User ID, password, and project code? Is there a priority system, and levels of “shut-down” for emergencies (e.g., President overrides other end-users)? Can an individual be denied access because of budget overrun (billed for system use)?
(c) “camera consolidation sites” are defined as consolidation points for real-time baseband collection of surveillance camera video from dispersed proximity camera locations that are re-transmitted at the site using broadband real-time service (e.g., fiber, wireless) to enterprise premise PMN Premise Switching Centers for distribution throughout the enterprise;
(d) “codec”, an abbreviation of “coder/decoder”, is defined as a device or program capable of performing transformations on data streams or signals. Codecs can both put the stream or signal into an encoded form (e.g,, digital for transmission, storage or encryption) and retrieve, or decode that form for viewing or manipulation in a format more appropriate for the intended operation (e.g., analog). Codecs used for videoconferencing and streaming media solutions often service “non-real-time” communication links. These multimedia data streams contain both audio and video data, and some form of metadata that permits lip-synchronization of audio and video between end-point codecs. Videoconferencing vendors (e.g., Tandberg, Polycom) have developed sophisticated algorithms and methodologies to overcome intra-stream, inter-stream, and end-point to end-point latency, and network jitter (jerky video and audio loss) to achieve end-point to end-point audio and video synchronization;
(e) “codec farm” is defined as a collection of rack mounted or shelf stacked codecs located at a enterprise site PMN Premise Switching Center;
(f) “continuous presence video” (CPV) is defined as a split screen display of multiparty session participants (3 or more) that is continuously shown on participant terminals. Local Call continuous presence engines are video Multiviewers at each site, working in combination with Cross Point Switches, that enable the simultaneous display of multiple video sources in real time; e.g., 4 inputs to 1 output with 4 quadrant display. Just as video Multiviewers, MCUs are Long Distance Call continuous presence engines. Multiviewers are intra-site and MCUs are inter-site continuous presence engines: For Local Calls, Multiviewers are needed for 3 or more participants; For Long Distance Calls, MCUs are required for 3 or more sites, and Multiviewers are required for sites with greater than 1 participant. For example, multiparty collaboration between 2 sites requires no MCU. However, sites with more than 1 participant require Multiviewers;
(g) “cross-point switches” (e.g., PESA, Ademco, Extron) also referred to as “matrix switchers” are defined as Multimedia Switches that route multiple inputs to multiple outputs route any input to any output, or multiple outputs, at any time. Just as with telephone systems, the switch manages the movement of multimedia information both between nodes within the premise (end-user-terminals and devices), and between nodes in the premise with external nodes (enterprise and foreign sites). Other sites are connected by either interlocked Cross-Point Switches (real-time trunk lines connecting input and output nodes on both site's Cross-Point Switches), or via non-real-time codecs and multipoint control units (e.g., IP or ISDN). Under Network Management System (NMS) management, cross-point switches control dynamic switching of shared PMN resource (e.g., Continuous Presence Engines, Audio Mixers, Data Recorders, Codecs, On-demand Servers, and end-user appliances) during multimedia sessions. Internally, the switcher consists of a series of distribution amplifiers and switchers, housed in a single enclosure and controlled by remote or front panel controllers. They are capable of routing a variety of NTSC/PAL and broadcast quality audio/video signal types, including: composite video, S-video, HDTV/component video, RGsB/RGBS/RGBHV video, stereo audio (balance/unbalanced). To meet differing application requirements, input/output configurations can be symmetrical or unbalanced (different number of inputs and output. Switchers are modular and can be coupled (inputs and outputs) to increase input or output capacity (e.g., increase end-user or surveillance camera input connections with “blocked” service) or provide limited service to multiple locations (e.g., Homeland Security Backup Center). “Blocked” service is a shared output path that can only be used by one input at a time (NMS manages resource sharing).
Multimedia nodes are predefined. As shown by example in FIG. 5, the low-end nodes are reserved for shared resources (e.g., trunk lines, on-demand servers, audio and video bridges, codecs, and data recorders (use for Home Land Security and not shown on FIG. 5), and the upper nodes are used for transceivers that connect via the Multimedia LAN to end-user nodes. Multimedia Switch capacity is determined by end-user node requirements and shared resource input and output requirements;
(h) “device manager” is defined as the Network Management System (NMS) function that manages the operation of PMN devices through a network of Premise Control Units. Device Manager uses the existing enterprise telephone and IP networks to deliver remote control commands to Premise Control Units. Premise Control Units are configured and controlled by a variety of protocols (e.g., ARP, UDP, TCP, TFTP, ICMP, HTTP, SNMP, DHCP and Telnet and even telephone call to wake-up the device (e.g., Telephone Hybrid)). Control commands conform to vendor hardware APIs and use device appropriate network interface (e.g., RJ45, DB-25), and serial interfaces (e.g., RS232, RS422, RS485). There are many products in the marketplace (e.g., Lantroniox, Digi Connectware) that satisfy PMN Control Unit requirements. The following premise hardware is controlled by Premise Control Units: end-user appliances, PMN Premise Switching Centers (on-demand servers, Multimedia Switches, Surveillance Cameras and Data Recorders, Codec Farms, and Telephone Hybrids), and Multipoint Controls;
(i) “end-user locations” are defined as desktops, meeting rooms, executive suites and boardrooms, Emergency Response Center Amphitheaters, and other enterprise premise and campus venues, and foreign end-users location, which are outside the enterprise;
(j) “end-user terminals” are defined as enterprise end-user audio/video appliances (e.g., telephone, display, camera) used by end-users to request and receive multimedia services. telephone audio (input and output), video output (e.g., TVs, video projectors, and PC internal or external video TV tuners and monitors), and video input (e.g., document and video cameras). Existing telephones, and typically existing video displays are used. An optional embodiment is a mix of telephone out-of-band audio means and in-band audio and video means. In this configuration end-user terminals include, but are not limited to: TVs, PCs, video projectors (audio and video output); document and video cameras (video input); TV tuners and monitors (video output); amplified speakers (audio output); and telephones (audio input and output). End-user terminals do not have dedicated or embedded codecs, multipoint control units, gatekeepers, and gateways. PCs are optional;
(k) “enterprise” is defined as one or more public or private sector organizations that operate as a single entity in their use of the Private Multimedia Network (PMN), and “foreign” is defined as an organization or entity that is outside the “enterprise”;
(l) “enterprise campus sites” are defined as locations within the premise complex that are served by interlocked Multimedia Switches (i.e., Cross-point Switches) connected by Multimedia LANs that deliver full multimedia service (services between nodes on interlocked cross-point switches are referred to as “Local Calls”);
(m) “enterprise geographically dispersed sites” are defined as locations that are linked by non-real-time codecs (e.g., IP, ISDN) that deliver full multimedia service (services between these sites are referred to as “Long Distance Calls”);
(n) “enterprise premise sites” are defined as the physical locations for end-users and Private Multimedia Network equipment (as shown in FIG. 2, End-user Participant Nodes, Multimedia LANs, PMN Premise Switching Center);
(o) “enterprise proximity sites” are defined as locations served by interlocked Multimedia Switches (i.e., Cross-point Switches) connected by real-time trunk lines (e.g., fiber, wireless) that deliver full multimedia service (services between nodes on interlocked cross-point switches are referred to as “Local Calls”);
(p) “foreign sites” are defined as locations outside the enterprise that collaborate (videoconference) or provide or receive other multimedia services (camera video) to/from enterprise sites, and receive services that are constrained by limitations imposed by their multimedia system (e.g., codec capabilities) and enterprise management control policy, which are enforced by the PMN control system (services between these sites are referred to as “Long Distance Calls”);
(q) “host-directed-video” (HDV) is defined as host directed switching of multimedia participant displays to a specific participant, similar to the chair of a meeting giving a participant the floor. The new speaker continues to view the last speaker. The host uses the telephone keypad or Internet-based human/computer interface to signal the Session Manager to switch screens. The telephone keypad is the preferred embodiment. VSV and HDV/PDV are the preferred embodiments;
(r) “long-haul”, also referred to as “Long Distance Call”, is defined as between served by a “non-real-time” transmission means;
(s) “multimedia session” is defined a set of multimedia service delivery processes and nested sub-processes with a discrete beginning and end, governed by business rules that control and coordinate activities and resource acquisition, use, and cost across time and place to produce specified outputs. The content delivered by such a process includes information that supports collaboration, decision-making, learning, and appeals to multiple senses, such as text, sound, video, graphics, and possibly, in future, tactile and olfactory feedback. Constrained by the scope and governance of multimedia service types, end-users specify schedule, participants, services, resources, and session operational rules. Enterprise management specifies management control rules and resource deployment. Brief multimedia sessions include videoconferencing, voicemail, media on demand, and advertising. Medium-length multimedia sessions include distance learning, telemedicine, emergency response collaboration, broadcasting, and administration. Long multimedia sessions include emergency response and security monitoring;
(t) “multipoint control unit”, often shortened to “MCU”, is defined as a device or program that eestablishes multimedia calls between three or more end-point codecs for converged voice, video and data conferences. MCUs essentially creates a point-to-point videoconference with each endpoint within a given conference, and uses sophisticated software and hardware to combine these inputs into a shared environment very like a physical meeting space. They also overcome latency and jitter to achieve end-point-to-end-point synchronization. Often referred to as a bridge, an MCU can provide audio-only services or any combination of audio, video and data, depending on the capabilities of each participant's end-point codec. Though some MCUs transcode between protocols (e.g., IP, ISDN) and provide gatekeeper services, the preferred embodiment is to use gateways to transcode between protocols and gatekeepers to address mapping and bandwidth management. The determinant of degree of device specialization is determined by price/performance, which changes over time;
(u) “multipoint control unit farms” are located in the PMN Control Center and are composed of rack mounted or shelf stacked Multipoint Control Unit (e.g., RadVision) bridging and switching devices managed by the Network Management System (NMS) software;
(v) “multiviewers” are defined as Multimedia Switches that, just as Multipoint Control Units (MCUs), combine multiple video inputs into a single, full motion, full color, “continuous presence” windowed output. They deliver a variety of NTSC/PAL and broadcast quality signals. Windowing can be fixed and programmable, including a built-in generator of source identification and border colors, real-time clock and date. Multiviewers occupy fixed positions on Cross Point Switches, and are either preset to perform specified functions or function controlled (e.g., RS232, RS422) by the Network Management System (NMS);
(w) “network management system” (NMS) is defined as the means by which the PMN Control Center controls system setup, operation, and maintenance at the direction of end-users, under the governance of the enterprise management control structure. NMS orchestrates execution of system sub-functions that perform defined management and operational control duties that span the PMN life cycle:
System Startup: Session Manager provides a structured dialogue that collects management control information from the System Administrator, which establishes business rules, and configures the PMN architecture, resources, and services to conform to enterprise requirements (refer to “multimedia session” and “session manager”). For example, the Telco/multimedia devices that individuals are allowed to use (e.g., only equipment in cubicles, office); equipment that most employees cannot use (e.g., Multiviewers for “Hollywood Squares” (continuous presence, conferences). Log-on scenarios requiring not only USER IDs and passwords, but also project codes; Priority overrides for emergencies and senior management imperatives. PMN's table driven structure facilitates customization and ongoing maintenance.
Operational Control: Session Manager facilitates end-user session management, under the governance of enterprise management control constraints: 1) Before sessions, Scheduler together with Resource Manager book participants, determine and record required services, and reserve resources; 2) During sessions, Session Manager together with Device and Resource Manager, startup (including security screening and resource acquisition), operate (including orchestration, interrupt handlers, and control of information flow) sessions; 3) End-of-sessions, Session Manager tears-down session (including releasing resources). Refer to “Scheduler”, “Resource Manager”, and “Device Manager”.
NMS is event-driven software. It provides real time service to events and multi-user changes of state. NMS handles all device interrupts; interrupts are specific to devices, system interrupts (e.g., scheduler, resource manager), and end-user signaling. To this end, the following are examples of NMS interrupt handlers: codec control, video switch control, on demand server control, media control, video bridge control, audio bridge control, audio mixer control, continuous presence (video matrix Multiviewers) multimedia switch control, scheduler control, active speaker control, host and participant signaling control, etc.
NMS's multimedia control system is built upon an audio conferencing platform that is a scalable, open, interoperable architecture that conforms to industry-standards (i.e., Signal Computing Systems Architecture, Scbus.) Refer to “Telco Audio Bridge”. NMS' Human/Computer Interface (HCI) is intuitive, uses the telephone, and mirrors the telephony conference paradigm. For example, to establish a conference call without scheduling, the meeting host uses the telephone to: Dial the PMN Control Center for videoconferencing service; Dial the 1^{st} part and connect; Hit the plunger; and continue the process until all parties are connected; and hit the plunger twice to start the conference. To simplify the calling process, PMN uses enterprise telephone numbers; therefore, there is only one telephone book. For more complex multimedia sessions and services (e.g., scheduling, selection of meeting formats, special resources, help assistance), NMS Scheduler provides Interactive Voice Response (IVR) to guide the end-user through the process. For example; videoconferencing session formats include: 1) Point-To-Point or Multi-Point (Continuous Presence or Voice or Host Switched Video (Participant Request for Floor)); 2) Listener Control (e.g., permission to audit); 3) Open or Closed Door Meetings (e.g., permission to join, entry rules when started, ad hoc initiations); 4) Local and Far-end Camera Control; 5) Special Equipment Requirements (e.g., document camera); 6) Special Software (e.g., PowerPoint, Whiteboard, Internet). Telephony-based HCI is the preferred embodiment for Systems Operation. However, there are situations requiring complex schedules and resources that would be better served by the IP version of the HCI. The IP version is the preferred embodiment for System Startup and Management. System Administrators are more adept at using Internet-based system;
(x) “non-real-time” is defined as communication means (e.g., bridges, switches, communication links, transmission) that are not immediate and are beset by latency and jitter. Non-real-time communication link and transmission means include IP, Ethernet, ISDN, and MPEG. Enterprise geographically dispersed sites have “non-real-time” communication means. Most private sector enterprise inter-site communication links are “non-real-time”;
(y) “participant-directed-video” (PDV) is defined as signaling that requests the host to give a participant the floor. The host uses the telephone keypad or Internet-based human/computer interface to signal the meeting host (refer to 2 (n) for further discussion). The telephone keypad is the preferred embodiment. VSV and HDV/PDV are the preferred embodiments;
(z) “phone book” is defined as a central directory of enterprise PMN end-users, and the scope of services and resources they can select. The Phone Book is structured for dynamic update. To facilitate intuitive operations and maintenance, end-users are given their enterprise phone numbers or extensions. Speed dial service is also provided to reduce keystrokes. Resources are related to end-users (owners) as well as physical location (e.g., premise and room) and relationship to other resources (e.g., hardwiring of resources to the Multimedia Switch, or either pool or direct relationship between Codecs and Telephone Hybrids). Ownership implies control (e.g., desktop telephone). Shared Resources are owned by the enterprise. The Phone Book reflects the standard relationships between people and resources. However, PMN allows ad hoc, temporal relationships to be created (e.g., scheduling a future conference using a different location (not the participant's office) and a different telephone. Generally, the new location and telephone and other end-user resources required for the session will be recorded in the Phone Book. However, if they are not and the Business Rule Book permits it, they can be placed in a temporal section of the Phone/Resource book. A section of the Phone Book is also set-aside for frequently called numbers outside the enterprise (Foreign entities that frequently engage in PMN collaboration sessions with Enterprise staff);
(aa) “PMN control center” is defined as a central office that performs 3 major functions for enterprise sites: PMN system control, Telephony-based audio server, and Inter-site multiparty video communications middleman. The Control Center can be located inside or outside (e.g., service bureau) the Enterprise. Just as Telco Central Office switching equipment joins subscribers' lines for connecting subscribers to each other and controls end-to-end connectivity, the PMN Control Center components provides similar services: 1) Internet and telephony-based end-user management and operational control; 2) telephony-based audio bridging services; 3) multipoint video and audio switching and bridging services via Multipoint Control Units (MCUs) and site codecs; and 4) Network Management System software and hardware (Network Manager (e.g., gatekeepers, gateways, QOS, Public Network and Internet connectivity), Resource Manager, Devise Manager, Session Manager, and Scheduler);
(bb) “real-time” is defined as communication means (e.g., bridges, switches, communication links, and transmission) that are immediate and provide synchronized audio and video. Real-time communication link and transmission means include telephony, wireless and fiber analog and broadband digital, twisted pair analog. Enterprise premise, campus, and proximity sites have “real-time” communication means. Public sector Municipal fiber loop inter-site connectivity is an example of proximity sites (e.g., school districts and government facilities);
(cc) “resource manager” is defined as the Network Management System (NMS) function that manages PMN resources. Resource Manager keeps track (maintains a calendar and resource inventory) of the location and disposition of all system hardware and communication facilities. Most importantly, it manages “shared” devices (e.g., Multimedia Switches, Premise Codec Farms, Telephone Hybrid Farms, On-demand Servers). For example, if an enterprise configures a PMN system with “blocked ports” on Cross Point Switches, Resource Manager has to keep track of session using the “gateway” path (“nailed-down” circuit) between switch modules (granular switch), and between differing inputs and outputs in an unbalanced switch (e.g., 160 input versus 128 outputs). Blocking is used to allow more ports to be connected to a switch than can be serviced simultaneously. It is based on the assumption that the system will rarely be fully utilized. Other shared resources require similar “share” management. If resources are not available, the end-user is given a “busy” signal.
During session scheduling, Resource Manager determines all resources required during the session, and reserves them (including end-to-end circuits) from the start date and time to projected session end. This includes both immediate and future scheduled sessions. During session startup, Resource Manager determines that all resources needed to support the session are available;
(dd) “scheduler” is defined as the Network Management System (NMS) function responsible for scheduling and maintaining the schedule for Multimedia Sessions. Scheduler, combined with Resource Manager, Phone and Business Rules Books, and real-time telephony-based (Telco Client) and Internet-based (IP Client) tools allow end-users to schedule sessions and participants, and reserve resources (e.g., devices, end-to-end circuits, and meeting rooms). Sessions can be “immediate” or “future”, and “recurring” or “one-time”. Session participants can either be confirmed by the Scheduler, or by the session host (end-user). The Scheduler uses Telco IVR and IP resources, as appropriate. For “future scheduled” meetings, Scheduler sends the host and participants a follow-up email outlining facts about the meeting;
(ee) “session manager” is defined as the Network Management System (NMS) function responsible for session start-up, operation, and teardown services. At session start-up, session manager insures that all scheduled and changed resources are available via Resource Manager, participants are properly identified, directed, and mentored (off-line and online), and that meeting protocol (e.g., “open” and “closed” door meetings) and security is adhered to; During sessions, continuing mentoring, as needed, and together with NMS and other NMS functions (e.g., Device Manager) responsible for servicing interrupt requests (e.g., telephone keypad signals to Session Manager and between participants), managing changes of state (e.g., new participants), and overall orchestration of session resource use and conformance to meeting protocol; At tear-down, responsible for servicing requests for time extension, enforcing requested, timed, and emergency shut-down procedures, release of session resources via Resource Manager, and creating accounting records for the billing of session services rendered to end-users. In the preferred embodiment, end-user billing is facilitated by telephony control (telephone keypad and IVR) and telephony-based audio, which is central to session management and service delivery;
(ff) “short-haul”, also referred to as “Local Call”, is defined as transmission within a premise or campus; or between sites served by “real-time” communication means (e.g., transcontinental “proximity” sites served by broadband fiber);
(gg) “synchronization” is defined as end-to-end isochronous video and lip synchronized audio and video, with differences imperceptible to the human eye and ear, between a plurality of Enterprise end-user terminals participating in multimedia sessions via “real-time” or a mix of “real-time” and “non-real-time” communication means;
(hh) “telco audio bridge” also referred to as “Telephony Server” is defined as the PMN central office that delivers telephony services to enterprise sites. The computer-based server is composed of cards that fit into computer chassis that serve as a PBX and Network Management System (NMS) control software. A Private Branch Exchange (PBX) is a privately owned, mini version of a telephone company's central office (CO) switch. The advantage of a PBX is the efficiency and cost gains of sharing a specific number of telephone lines among a large group of users. The real-time, multi-party cards (e.g., NMS) support over 500 seats (multiple cards are placed in a single chassis), over 100 ports, and digital trucking. Multiple cards can be placed in a computer chassis. Though not designed for video conferencing, commercial telephony bridges contain programmable API call control features that facilitate implementation of collaboration applications (e.g., videoconferencing, distance learning): 1) create and delete a conference; 2) active talker status (capability to determine which participant is talking at a given time); 3) coaching mode (the ability to selectively control which conference members can hear chosen participants without the knowledge of other conference members); 4) echo cancellation (prevents disturbing feedback and echoes); 5) data logging (recording full-duplex conference calls); 6) IVR (Interactive Voice Response for management and operational control end-user dialogue-based system settings); 7) Call control setup and tear-down; 8) Real-time faxing, and analog and IP voice; 9) T1 and E1 interfaces;
(ii) “voice switched video” (VSV) is defined as automatic switching of multimedia session participant displays to show the video of the predominant speaker. The predominant speaker continues to view the last predominant speaker. Network Management System (NMS) uses the telephony-based audio bridge to determine the predominant speaker. VSV and HDV/PDV are the preferred embodiments;

4. The system of claim 1 wherein a network of diverse real-time communication means and components are integrated and configured to work in tandem to deliver lip synchronized audio and video end-to-end to and between a plurality of end-user terminals, and between enterprise terminals and foreign site codecs comprises:
(a) PMN architecture compliance with industry standards facilitates interoperability between differing communication means and vendors (refer to claim 2).
(b) differing in-band and out-of-band real-time audio and video communication means are inherently isochronous (two-way without delay) and lip-synchronized because differences are imperceptible to the human eye and ear. For example: surveillance camera baseband transmission to consolidation sites (analog twisted pair), and analog and broadband digital trunk lines between Cross-Point Switches (fiber, wireless, twisted pair); Multimedia LANs within sites (analog/twisted pair); telephony-based multimedia audio between all enterprise sites.

5. The system of claim 4 wherein end-users use existing enterprise telephones for input and output audio, Telco service provider telephone service and enterprise PBXs, as needed, and PMN Telco Audio Bridge to deliver lip-synchronized, real-time, point-to-point and multipoint audio service to a plurality of end-user terminal locations coupled to the same or interlocked Cross Point Switches.

6. The system of claim 4 wherein a real-time network of Cross Point Switches that interconnect end-user terminals via Multimedia LANs terminated by analog signal extender transceivers deliver lip-synchronized point-to-point and multipoint service to a plurality end-user terminals coupled to the same or interlocked Cross Point Switches comprising the following configuration:
(a) enterprise site end-user terminals comprised of real-time NTSC, PAL, or broadcast quality video, as appropriate, AV (audio/video) appliances.
(b) end-user terminals are coupled to input and output ports on real-time analog signal extender transceivers that transmit signals 1,000 feet or more (e.g., Extron) over Multimedia LANs that provide full duplex service with imperceptible loss of signal quality end-to-end. The transceiver preferred embodiment is video only, with audio provided by telephony-based service.
(c) real-time Multimedia LANs, dark twisted pair wireline full duplex network, is terminated by analog signal extender transceivers at the end-user node hub and PMN head-in-hub ends. The preferred embodiment is for the PMN Switching Center head-in-hub to be located either at the site LAN or telephone head-in and use dark wire pairs in existing LAN or telephone wiring sheaths;
(d) PMN Switching Center head-in hub transceivers coupled to real-time analog Cross Point Switches (e.g., PESA) on video, and optionally audio, input and output nodes. The preferred embodiment is video only connectivity with audio provided by telephony-based service.
(e) Multiviewers coupled to Cross Point Switches provide multipoint continuous presence service, and audio mixers coupled to Cross Point Switches provide bridged CD quality audio-audio option for Executive Board Rooms and Homeland Security Amphitheaters.
(f) interlocked Cross Point Switch trunk lines provide real-time lip-synchronized communication means between enterprise premise, campus, and proximity sites.

7. The system of claim 4 wherein diverse non-real-time communication means and components are integrated and configured to work in tandem to overcome inherent video quality and lip-synchronization audio and video problems between a plurality of end-points (codecs) participating in multiparty multimedia sessions between a plurality of enterprise and foreign sites comprises the following configuration:
(a) PMN architecture compliance with industry standards (e.g., ITU, IETF, ISO, MPEGIF) facilitates interoperability between differing communication means and vendors (refer to claim 2);
(b) PMN Switching Center codecs, which interconnect enterprise geographically dispersed sites, are the end-points for “non-real-time” communication links;
(c) high-end codecs, typically used in executive conference rooms, boardrooms, and Homeland Security amphitheaters, have overcome video quality and lip-synchronization audio and video problems (e.g., jitter, latency). Manufacturers of these products provide sophisticated technology to overcome communication link anomalies by delivering end-to-end multi-site digital audio and video communication link synchronization for Long Distance Calls;
(d) PMN Switching Center Codec Farms, which convert inter-site signals to digital for transmission and back to analog at delivery, provide point-to-point and limited multipoint communication link services (e.g., voice switched video) between sites connected by a network of codecs; Sites connected by codecs and Multipoint Control Units provide “Continuous Presence” multipoint service to a plurality of end-users. The preferred embodiment is multipoint service provided by placing PMN Control Center Multipoint Control Units at the center of transmissions between site codecs. This is the preferred embodiment. The architecture also supports codecs with embedded Multipoint Control Units, which deliver multipoint service between sites without PMN Control Center intervention;
(e) PMN Control Center, Multipoint Control Unit Farms serve as the multipoint intermediary between a plurality of codecs engaged in collaboration and other multimedia services. Multipoint Control Unit vendors provide sophisticated technology to overcome latency by delivering end-to-end, end-point multi-site audio and video communication link synchronization;
(f) PMN Control Center Network Manager combined with enterprise network management facilities (e.g., QOS methodologies, gatekeepers, gateways, firewalls and proxies) overcome inherent non-real-time network anomalies.

8. The system of claim 4 wherein real-time communication means are aligned and combined with non-real-time communication means to deliver lip-synchronized audio and video to and between a plurality of end-user terminals and devices within and between a plurality of sites participating in multimedia sessions configured as follows:
(a) PMN Premise Switching Center Cross-Point Switches that control the flow of multimedia (video and audio) information throughout the system comprising:
i. cross-point switches control the flow of multimedia information between Local Call sites via Multimedia LANs and trunk lines connecting interlocked Cross-point Switches as described in claims 5 and 6;
ii. cross-point switches control the flow of multimedia information between Long Distance Call sites (i.e., between enterprise geographically dispersed enterprise sites, and between enterprise and foreign sites) via PMN Premise Switching Center codecs and PMN Control Center multipoint control units (MCUs) as describe in claim 7:

9. The method of claim 8 wherein end-user terminal and codec video and audio (the preferred embodiment is video-only) are aligned and combined comprising the following steps:
(a) couple codec analog video and audio, input and output ports to Cross Point switch input and output ports to combine real-time and non-real-time synchronized communication means:
i. Codec output is aligned synchronized video and audio;
ii. Codec input is unaligned synchronized video and audio;
(b) for Long Distance Calls, all end-user terminal participant video, and optional audio, must flow through the PMN Premise Switching Center Codec Farm for real-time/non-real-time alignment:
i. for Voice Switched Video (VSV), the active speaker is determined by NMS test of the Telco Audio Bridge, and the Multimedia Switch with the “active speaker” sends the speaker's video to the codec for broadcast to participant terminals except the active speaker, which receives the last active speaker's video;
ii. for Host Directed Video (HDV) and Participant Requested Video (PRV) (host acknowledged), which are triggered by telephone keypad signaling, the Multimedia Switch with the “selected speaker” sends the speaker's video to the codec for broadcast to participant terminals except the selected speaker, which receives the last selected speaker's video;
iii. for a multiparty site with Continuous Presence Video (CPV), the Multimedia Switch sends the Multiviewer “Hollywood Squares” windowed video to the Codec;
iv. for a point-to-point site the Multimedia Switch sends the participant's video to the Codec.
(c) once aligned, there is no loss of alignment or signal quality between end-user terminals and Cross-Point switches because the communication link is real-time;
(d) As shown in FIG. 5, in addition to analog signal extender transceivers and codecs, other communication links and devices that can be coupled to Cross Point switches and shared in both Local and Long Distance Calls include: analog and broadband digital trunk lines (e.g., fiber, wireless, twisted pair transport for surveillance cameras, inter-site communication, and other Enterprise facilities), “Continuous Presence” Multiviewers (e.g., Zandar), and CD-Quality Audio Mixers on the output side; and analog and broadband digital trunk lines, “Continuous Presence” Multiviewers, CD-Quality Audio Mixers, Video Servers (e.g., education courseware), and cable TV on the input side.

10. The method of claim 8 wherein end-user terminal telephony and codec audio are aligned and combined comprising the following steps:
(a) couple codec analog audio input and output ports to corresponding ports on Telephone Hybrids;
(b) couple Telephone Hybrid voice ports to Telco service provider voice ports to exchange (send and receive) voice audio signals with the Telco Audio Bridge.
(c) for Long Distance Calls all end-user terminal participant audio must flow through the PMN Premise Switching Center Codec Farm for alignment:
i. input is unaligned, bridged (as needed), synchronized telephone handset audio output flowing to Telco service provider, to Telco Audio Bridge, to Codec;
ii. output is aligned, bridged (as needed), synchronized Codec output flowing to Telephone Hybrid, to Telco service provider, to Telco Audio Bridge to end-user terminal telephone headset speakers;
(d) once aligned, there is no loss of alignment or signal quality between end-user terminals and Cross-Point switches because the communication link is real-time;

11. The system of claim 1, wherein the Network Management System (NMS) is the intuitive means by which end-users, under enterprise management control governance, perform system launch, operational control, and system management tasks that match business needs comprising:

12. The method of claim 11, wherein NMS provides the following system launch services:
(a) Session Manager provides a structured dialogue with a designated member of enterprise senior management or their designee that facilitates collection of management control business rules that are recorded in the Business Rule Book. This function has a senior management security level, and entries must be approved by senior management;
(b) Session Manager provides a structured dialogue with the enterprise System Administrator to define the PMN system control tables (e.g., Phone Book, Resources, Networks, Session Processes,) and configure the system for integration with other enterprise systems.

13. The method of claim 11, wherein NMS provides enterprise end-users with the following operational control services:
(a) Before sessions, Scheduler together with Resource Manager books participants, determines and records required services, and reserves resources;
(b) During sessions, Session Manager together with Device and Resource Manager, startup (including security screening and resource acquisition), operate (including process orchestration, interrupt handlers, and device and information flow control) sessions;
(c) End sessions, Session Manager tears-down session (including releasing resources).

14. The method of claim 11, wherein NMS provides enterprise System Administrators with the following ongoing system management services:
(a) Session Manager provides System Administrators with structured dialogues to facilitate ongoing system management of system control tables;
(b) Network Manager provides System Administrators with real-time network monitoring reports, including alarms;
(c) Resource Manager provides System Administrators with real-time resource utilization reports, including alarms. (d) Session Manager facilitates Administrator maintenance of system tables (e.g., configuration, end-user profile, business rules) using appropriate security clearances, and use of Network Manager to monitor and manage the PMN Network, including gateways, firewalls and proxies, support of public, Internet, and Intranets;

15. The method of claim 11, wherein NMS provides enterprise end-users and system administrators with an intuitive human/computer interface (HCI) and session control that matches business needs comprising:
(a) existing enterprise telephones for audio and session control;
(b) Telephone and audio conferencing paradigms, which are well understood and require minimal training (IVR provided for more complex tasks);
(c) Telephone key pads used for session scheduling and dynamic change of state signaling;
(d) Single toll free number dialing to request services (also supports speed dialing) and enterprise telephone book mirroring (use same enterprise telephone book telephone numbers);
(e) Meeting schedule can be immediate or future; Confirmed by scheduler or meeting host; Recurring or one-time;
(f) IVR-based Socratic scheduling questions reduce data entry: point-to-point (2 participants) or multipoint (greater than 2 participants); if multipoint, continuous presence (scarce resource), or voice or host directed switching; if host directed, (e.g., participant request for floor);
(g) Virtual meeting rooms that mirror the format, controls, and rituals followed by organizations in physical face-to-face collaboration and education (e.g., listener protocol, open and closed door meeting entry, entry after meeting start, signaling the host to get the floor, requesting more time, inviting participants during meeting);
(h) Telephone keypad operational appliance and device control (e.g., surveillance camera selection, and PAN, tilt, and zoom control)
(i) Use of special software (e.g., Microsoft PowerPoint, Whiteboard, and Internet).
(j) Accounting records and billing of session resources and services rendered;
(k) Supports Internet-based HCI for complex tasks (e.g., complex scheduling, system launch and administration).

16. The method of claim 11, wherein NMS is event-driven software that provides real-time services to events and multi-user changes of state.

17. The method of claim 1, wherein isochronous NTSC TV quality or better video is transmitted to and between end-user terminals and devices comprises:
(a) End-user appliances (e.g., video cameras, TV displays) that range from NTSC quality to boardroom and broadcast quality, codecs, and MCUs are the determinants of end-to-end quality. Real-time communication means are neutral; they deliver the same quality signal they are given.
(b) For Long Distance Calls PMN uses non-real-time codecs and Multipoint Control Units (MCUs) are the same or better quality than the codecs used in Boardrooms. They deliver a minimum of NTSC between end-user terminal and foreign site codecs;
(c) For Local Calls PMN uses real-time analog signal extender transceivers and Premise Switching Center switches (e.g., Cross Point, Multiviewer) that transmit video between end-user terminals connected to the same or interlocked Multimedia Switches via Multimedia LANs without loss of signal quality.

18. A multimedia architecture that manages, shares, and eliminates use of expensive dedicated capital-intensive resources, thereby significantly reducing Enterprise capital outlay per end-user. Many of these resources are typically deployed at point of service (e.g., desktops, meeting rooms).

19. The method of claim 18 wherein PMN Control Center optimizes resource management by providing the following services:
(a) End-user Human/Computer Interface (Telephony-based Interactive Voice Response (IVR), telephone keypad, Internet);
(b) Scheduler (schedule (immediate and future) and reserve resources required to book a session),
(c) Resource Manager (e.g., managing “nailed-down” circuit resources),
(d) Session Manager (insuring all resources are available and that session protocol is followed and billing is accurate),
(e) Device Manager (controlling operation of PMN Control Center and Enterprise Premise hardware during session setup, operation, and teardown).

20. The method of claim 18, wherein resource deployment is optimized by centralizing resources at PMN Control Center and sharing the following resources with all sites:
(a) Multipoint Control Units (MCUs),
(b) Telco Audio Bridge (computer hardware, conference bridge computer cards, NMS software),
(c) Network Manager (gatekeepers, gateways).

21. The method of claim 18, wherein resource deployment is optimized by centralizing resources at each enterprise premise site and sharing them with end-users at the site comprise:
(a) PMN Premise Switching Center (Codec Farm, Telephone Hybrid Farm;
(b) Multimedia Switches (Transceiver Hub, Cross Point Switches, Continuous Presence Multiviewers, Audio Mixers, On-Demand Servers, Trunk Lines);
(c) Multimedia LAN (use existing LAN and telephone wire lines);
(d) End-user Appliances (uses existing telephones, and Audio/Video devices (e.g., computers, monitors and TVs).

22. The method of claim 18, wherein use of dynamic real-time switching methodologies (e.g., VSV, HDV/PRV) eliminate the need for PMN Control Center MCUs.

23. The method of claim 18, wherein use of telephony-based audio and control eliminate the need for expensive multimedia resources that are commonly used at desktops or in meeting rooms:
(a) telephony-based audio eliminates the need for audio mixers, transceiver audio, end-user appliance speakers, cross point switch audio, computers. Therefore, telephony-based architecture supports deployment of multimedia (e.g., videoconferencing) in environments where there are no computers (e.g., hotel rooms, meeting rooms).
(b) telephony-based audio and control combined with real-time end-to-end video (e.g., Municipal fiber loops) in addition to audio equipment claimed in (a), they eliminate the need for inter-site Enterprise (e.g., codecs, telephone hybrids) and PMN Control Center (e.g., Multimedia Control Units, gatekeepers, gateways) resources. If collaboration with Foreign sites (outside the Enterprise) is required, codec and Multimedia Control unit resources can be centralized at the Central PMN Control Center rather than deploying codecs at each site. In this configuration, since outside collaboration is generally much less than Enterprise collaboration, codec and MCU resource requirements will be significantly reduced.
(c) telephony-based voice switched video eliminates the need for “Continuous Presence” Multiviewers that are not only expensive, but become a bottleneck for local (within premise or campus) and long-distance (between sites) multiparty collaboration (videoconferencing).
